(19) United States
(12) Patent Application Publication
(10) Pub. No.: US 2021/0155821 A1
(43) Pub. Date: May 27, 2021

(54) FLUOROPOLYMER NANOPARTICLE COATING COMPOSITION

(71) Applicant: 3M INNOVATIVE PROPERTIES COMPANY, St. Paul, MN (US)

(72) Inventors: Naiyong Jing, St. Paul, MN (US); Tho Q. Nguyen, Bloomington, MN (US); Klaus Hintzer, Kastl (DE)

(21) Appl. No.: 17/045,853

(22) PCT Filed: Jun. 11, 2019
(86) PCT No.: PCT/IB2019/054870

§ 371 Date: Oct. 7, 2020

Related U.S. Application Data
(60) Provisional application No. 62/683,769, filed on Jun. 12, 2018.

(51) Int. Cl. C09D 127/18; C08L 27/18

(52) U.S. Cl. CPC C09D 127/18; C08L 27/18

(57) ABSTRACT

A method of making a fluoropolymer coating composition is described comprising blending a latex comprising crystalline submicron fluoropolymer particles with a latex comprising amorphous fluoropolymer particles. The method further comprises coagulating and drying the blended latexes and dissolving the dried blended latexes in a fluorinated solvent. Also described is a fluoropolymer (e.g. coating) composition comprising crystalline submicron fluoropolymer particles dispersed in a solution of fluorinated solvent and amorphous fluoropolymer; the fluoropolymer composition after removal of the solvent; and a substrate comprising a coated surface of the fluoropolymer composition. In each of these embodiments, he amorphous fluoropolymer comprises at least 90 wt-% of polymerized units derived from perfluorinated monomers selected from tetrafluoroethene (TFE) and one or more unsaturated perfluorinated alkyl ethers.

### SUMMARY

In one embodiment, a method of making a fluoropolymer coating composition is described comprising blending a latex comprising crystalline submicron fluoropolymer particles with a latex comprising amorphous fluoropolymer particles. The amorphous fluoropolymer particles comprise at least 90 wt-% of polymerized units derived from perfluorinated monomers selected from tetrafluoroethene (TFE) and one or more unsaturated perfluorinated alkyl ethers. The method further comprises coagulating and drying the blended latexes and dissolving the dried blended latexes in a fluorinated solvent.

In another embodiment, a fluoropolymer (e.g. coating) composition is described comprising crystalline submicron fluoropolymer particles dispersed in a solution of fluorinated solvent and amorphous fluoropolymer. The amorphous fluoropolymer comprises at least 90 wt-% of polymerized units derived from perfluorinated monomers selected from tetrafluoroethene (TFE) and one or more unsaturated perfluorinated alkyl ethers.

In another embodiment, a (e.g. dried and cured) fluoropolymer composition is described comprising crystalline submicron fluoropolymer particles dispersed in an amorphous fluoropolymer binder layer. The amorphous fluoropolymer binder layer comprises at least 90 wt-% of polymerized units derived from perfluorinated monomers selected from tetrafluoroethene (TFE) and one or more unsaturated perfluorinated alkyl ethers.

In another embodiment, a substrate comprising a coated surface is described wherein the surface comprises the fluoropolymer composition described herein.

In each of these embodiments, the unsaturated perfluorinated alkyl ether preferably has the general formula

R_{f}—O—(CF₂)ₙ—CF═CF₂

wherein n is 1 or 0 and R_{f} is a perfluoroalkyl or perfluoroether group.

In some embodiments, the fluorinated solvent comprises a branched, partially fluorinated ether and wherein the partially fluorinated ether corresponds to the formula:

Rf—O—R

wherein Rf is a selected from perfluorinated and partially fluorinated alkyl or (poly)ether groups and R is selected from partially fluorinated and non-fluorinated alkyl groups.

### BRIEF DESCRIPTION OF THE DRAWING

FIG. 1A and FIG. 1B are atomic force microscopy photomicrographs showing the surface of an illustrative coatings before (FIG. 1A) and after (FIG. 1B) rubbing.

### DETAILED DESCRIPTION

Presently described is a method of making a fluoropolymer coating composition from fluoropolymer latexes, coating compositions comprising certain fluoropolymers and a fluorinated solvent, coated substrates, and methods of making the compositions and the coated substrates.

The coating compositions generally comprise certain amorphous fluoropolymers dissolved in a fluorinated solvent and crystalline fluoropolymer particles dispersed in the amorphous fluoropolymer solution.

The amorphous and crystalline fluoropolymers can be prepared by methods known in the art, such as bulk, suspension, solution or aqueous emulsion polymerzsation. For example, the polymerization process can be carried out by free radical polymerization of the monomers alone or as solutions, emulsions, or dispersions in an organic solvent or water. Seeded polymerizations may or may not be used.

In some embodiments, the fluoropolymers are prepared by aqueous emulsion polymerization with or without fluorinated emulsifiers.

The amorphous and crystalline fluoropolymers may have a monomodal or bi-modal or multi-modal weight distribution. The fluoropolymers may or may not have a core-shell structure. Core-shell polymers are polymers where towards the end of the polymerization, typically after at least 50% by mole of the comonomers are consumed, the comonomer composition or the ratio of the comonomers or the reaction speed is altered to create a shell of different composition.

In one embodiment, such coating composition is prepared by blending a latex containing crystalline fluoropolymer particles with a latex containing amorphous fluoropolymer particles. The fluoropolymer particles typically have a small average particle diameter, for example less than 400 nm, but may be larger if especially when the applied coating will be rubbed after cure. For example, the fluoropolymer particle size range may be about 50 to about 1000 nm, or about 50 to about 400 nm, or about 50 to about 200 nm.

The latexes can be combined by any suitable manner such as by vortex mixing for 1-2 minutes. The method further comprises coagulating the mixture of latex particles. Coagulation may be carried out, for example, by chilling (e.g., freezing) the blended latexes or by adding a suitable salt (e.g., magnesium chloride). Chilling is especially desirable for coatings that will be used in semiconductor manufacturing and other applications where the introduction of salts may be undesirable. The method further comprising optionally washing the coagulated mixture of amorphous fluoropolymer particles and crystalline fluoropolymer particles. The washing step may substantially remove emulsifiers or other surfactants from the mixture and can assist in obtaining a well-mixed blend of substantially unagglomerated dry particles. In some embodiments, the surfactant level of the resulting dry particle mixture may, for example, be less than 0.1% by weight, less than 0.05% by weight or less than 0.01% by weight. The method further comprises drying the coagulated latex mixture. The coagulated latex mixture can be dried by any suitable means such as air drying or oven drying. In one embodiment, the coagulated latex mixture can be dried at 100° C. for 1-2 hours.

The dried coagulated latex mixture can be dissolved in a solvent suitable for dissolving the amorphous fluoropolymer particles to form a stable coating composition containing a homogeneous dispersion of the crystalline fluoropolymer particles in a solution of the amorphous fluoropolymer.

The coating solution can be utilized to provide a coating on a substrate by applying a layer of the coating composition to a surface of a substrates and drying (i.e. removing the fluorinated solvent by evaporation) the coating composition.

In some embodiments, the method further comprises rubbing (e.g. buffing, polishing) the dried layer thereby forming an amorphous fluoropolymer binder layer containing crystalline submicron fluoropolymer particles.

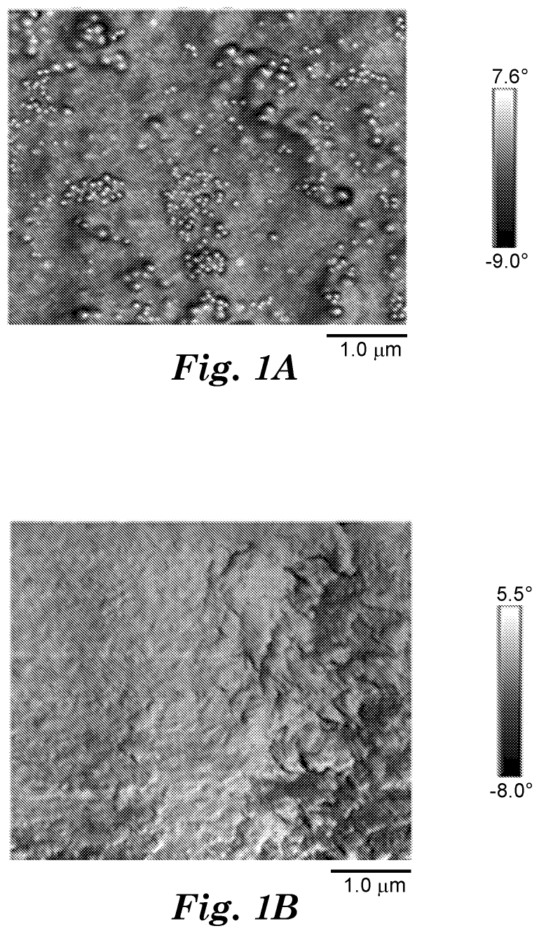

FIG. 1A and FIG. 1B are atomic force microscopy photomicrographs showing the surface of an illustrative coating before (FIG. 1A) and after (FIG. 1B) rubbing. In FIG. 1A, before rubbing, the crystalline submicron fluoropolymer particles are evident as a plurality of white dots. However, in FIG. 1B, after rubbing, the individual white dots are no longer visible. The submicron crystalline fluoropolymer particles at the coating surface forms a thin, continuous or nearly continuous fluoropolymer surface layer disposed on the underlying coating comprised of the amorphous fluoropolymer. In preferred embodiments the thin crystalline fluoropolymer layer is relatively uniformly smeared over the underlying coating and appears to be thinner and more uniform than might be the case if the fluoropolymer particles had merely undergone fibrillation (e.g., due to orientation or other stretching).

The average roughness (Ra) can be determined from the topographic images of FIG. 1A and FIG. 1B. Average roughness (Ra) is the arithmetic average of the absolute values of the surface height deviation measured from the mean plane. In FIG. 1A, before rubbing, Ra=42 nm. However, in FIG. 1B, after rubbing, Ra=21 nm. Thus, it can be concluded that the surface is smoother in FIG. 1B after rubbing. In some embodiments, Ra is at least 40 or 50 nm, ranging up to 100 nm before rubbing. In some embodiments, the surface after rubbing is at least 10, 20, 30, 40, 50 or 60% smoother. In some embodiments, Ra is less than 35, 30, 25, or 20 nm after rubbing.

A variety of rubbing techniques can be employed at the time of coating formation or later when the coated article is used or about to be used. Simply wiping or buffing the coating a few times using a cheesecloth or other suitable woven, nonwoven or knit fabric will often suffice to form the desired thin layer. Those skilled in the art will appreciate that many other rubbing techniques may be employed. Rubbing can also reduce haze in the cured coating.

A variety of crystalline fluoropolymer particles may be employed including mixtures of different crystalline fluoropolymer particles. The crystalline fluoropolymer particles typically have high crystallinity and therefore a significant melting point (peak maximum) as determined by differential scanning calorimetry in accordance with DIN EN ISO 11357-3:2013-04 under nitrogen flow and a heating rate of 10° C./min.

For example, the crystalline fluoropolymer particles may include particles of fluoropolymers having a Tm of at least 100, 110, 120, or 130° C. In some embodiments, the crystalline fluoropolymer particles may include particles of fluoropolymers having a Tm no greater than 350, 340, 330, 320, 310 or 300° C.

The crystalline fluoropolymer particles typically have a fluorine content greater than about 50 weight percent. Also, the fluoropolymer particles may include particles of fluoropolymers having a fluorine content between about 50 and about 76 weight percent, between about 60 and about 76 weight percent, or between about 65 and about 76 weight percent.

Representative crystalline fluoropolymers include, for example, perfluorinated fluoropolymers such as 3M™ Dyneon™ PTFE Dispersions TF 5032Z, TF 5033Z, TF 5035Z, TF 5050Z, TF 5135GZ, and TF 5070GZ; and 3M™ Dyneon™ Fluorothermoplastic Dispersions PFA 6900GZ, PFA 6910GZ, FEP 6300GZ, and THV 340Z.

Other suitable fluoropolymer particles are available from suppliers such as Asahi Glass, Solvay Solexis, and Daikin Industries and will be familiar to those skilled in the art.

Commercial aqueous dispersion usually contain non-ionic and/or ionic surfactants at concentration up to 5 to 10 wt. %. These surfactants are substantially removed by washing the coagulated blends. A residual surfactant concentration of less than 1, 0.05, or 0.01 wt. % may be present. Quite often it is more convenient to use the “as polymerized” aqueous fluoropolymer-latexes as they do not contain such higher contents of non-ionic/ionic surfactants.

As previously described, the crystalline fluoropolymers have a melt point that can be determined by DSC. Crystallinity depends on the selection and concentration of polymerized monomers of the fluoropolymer. For example, PTFE homopolymers (containing 100% TFE-units) have a melting point (Tm) above 340° C. The addition of comonomers, such as the unsaturated (per)fluorinated alkyl ethers, reduces the Tm. For example, when the fluoropolymer contains about 3-5 wt. % of polymerized units of such comonomer, the Tm is about 310° C. As yet another example, when the fluoropolymer contains about 15-20 wt. % of polymerized units of HFP, the Tm is about 260-270° C. As yet another example, when the fluoropolymer contains 30 wt. % of polymerized units of (per)fluorinated alkyl ethers (e.g. PMVE) or other comonomer(s) that reduce the crystallinity the fluoropolymer no longer has a detectable melting point via DSC, and thus is characterized as being amorphous.

In some embodiments, the crystalline fluoropolymer particles contain at least 40, 45, 50, 55, 60, 65, 70, 75, 80, 85, 90, 95 or about 100 wt. % of polymerized units of TFE. Further, the crystalline fluoropolymer particles typically comprise a lower concentration of unsaturated (per)fluorinated alkyl ethers (e.g. PMVE) than the amorphous flurorpolymer. In typical embodiments, the crystalline fluoropolymer particles contain less than 30, 25, 20, 15, 10, or 5 wt-% of polymerized units of (per)fluorinated alkyl ethers (e.g. PMVE).

In some embodiments, the crystalline fluororpolymers are copolymers formed from the constituent monomers known as tetrafluoroethylene (“TFE”), hexafluoropropylene (“HFP”), and vinylidene fluoride (“VDF,” “VF2,”). The monomer structures for these constituents are shown below:

TFE: CF₂═CF₂ (1)

VDF: CH₂═CF₂ (2)

HFP: CF₂═CF—CF₃ (3)

In some embodiments, the crystalline fluoropolymer consists of at least two of the constituent monomers (HFP and VDF), and in some embodiments all three of the constituents monomers in varying amounts.

The Tm depends on the amounts of TFE, HFP, and VDF. For example, a fluoropolymer comprising about 45 wt. % of polymerized units of TFE, about 18 wt. % of polymerized units of HFP, and about 37 wt. % of polymerized units of VDF has a Tm of about 120° C. As yet another example, a fluoropolymer comprising about 76 wt. % of polymerized units of TFE, about 11 wt. % of polymerized units of HFP, and about 13 wt. % of polymerized units of VDF has a Tm of about 240° C. By Increasing the polymerized units of HFP/VDF, while reducing the polymerized units of TFE, the fluoropolymer becomes amorphous. An overview of crystalline and amorphous Fluoropolymers is given in: Ullmann's Encyclopedia of Industrial Chemistry (7^{th} Edition, 2013 Wiley-VCH Verlag. 10. 1002/14356007.a11 393 pub 2) Chapter: Fluoropolymers, Organic.

The crystalline fluoropolymer particles and amorphous fluoropolymer particles may be combined in a variety of ratios. For example, the coating composition contains about 5 to about 95 weight percent crystalline fluoropolymer particles and about 95 to about 5 weight percent amorphous fluoropolymer, based on the total weight percent of solids (i.e. excluding the solvent). In some embodiments, the coating composition contains about 10 to about 75 weight percent crystalline fluoropolymer particles and about 90 to about 25 weight amorphous fluoropolymer.

In some embodiments, the coating composition contains about 10 to about 50 weight percent crystalline fluoropolymer particles and about 90 to about 50 weight percent amorphous fluoropolymer. In some embodiments, the coating composition contains about 10 to about 30 weight percent crystalline fluoropolymer particles and about 90 to about 70 weight percent amorphous fluoropolymer.

The amorphous fluoropolymers described herein are copolymers that comprise predominantly, or exclusively, (e.g. repeating) polymerized units derived from two or more perfluorinated comonomers. Copolymer refers to a polymeric material resulting from the simultaneous polymerization of two or more monomers. The comonomers include tetrafluoroethene (TFE) and one or more unsaturated (e.g. alkenyl, vinyl) perfluorinated alkyl ethers.

In some favored embodiments, the one or more unsaturated perfluorinated alkyl ethers are selected from the general formula:

R_{f}—O—(CF₂)ₙ—CF═CF₂

wherein n is 1 (allyl ether) or 0 (vinyl ether) and R_{f} represents a perfluoroalkyl residue which may be interrupted once or more than once by an oxygen atom. R_{f} may contain up to 10 carbon atoms, e.g. 1, 2, 3, 4, 5, 6, 7, 8, 9 or 10 carbon atoms. Preferably R_{f} contains up to 8, more preferably up to 6 carbon atoms and most preferably 3 or 4 carbon atoms. In one embodiment R_{f} has 3 carbon atoms. In another embodiment R_{f} has 1 carbon atom. R_{f} may be linear or branched and it may contain or not contain a cyclic unit. Specific examples of R_{f} include residues with one or more ether functions including but not limited to:

—(CF₂)—O—C₃F₇,

—(CF₂)₂—O—C₂F₅,

—(CF₂)ᵣ₃—O—CF₃,

—(CF₂—O)—C₃F₇,

—(CF₂—O)₂—C₂F₅,

—(CF₂—O)₃—CF₃,

—(CF₂CF₂—O)—C₃F₇,

—(CF₂CF₂—O)₂—C₂F₅,

—(CF₂CF₂—O)₃—CF₃,

Other specific examples for R_{f} include residues that do not contain an ether function and include but are not limited to —C₄F₉, —C₃F₇, —C₂F₅, —CF₃, wherein the C₄ and C₃ residues may be branched or linear, but preferably are linear.

Specific examples of suitable perfluorinated alkyl vinyl ethers (PAVE's) and perfluorinated alkyl allyl ethers (PAAE's) include but are not limited to perfluoro (methyl vinyl) ether (PMVE), perfluoro (ethyl vinyl) ether (PEVE), perfluoro (n-propyl vinyl) ether (PPVE-1), perfluoro-2-propoxypropylvinyl ether (PPVE-2), perfluoro-3-methoxy-n-propylvinyl ether, perfluoro-2-methoxy-ethylvinyl ether, CF₂═CF—O—CF₂—O—C₂F₅, CF₂═CF—O—CF₂—O—C₃F₇, CF₃—(CF₂)₂—O—CF(CF₃)—CF₂—O—CF(CF₃)—CF₂—O—CF═CF₂ and their allyl ether homologues. Specific examples of allyl ethers include CF₂═CF—CF₂—O—CF₃, CF₂═CF—CF₂—O—C₃F₇, CF₂—CF—CF₂—O—(CF₃)₃—O—CF₃.

Further examples include but are not limited to the vinyl ether described in European patent application EP 1,997,795 B1.

Perfluorinated ethers as described above are commercially available, for example from Anles Ltd. St. Petersburg, Russia and other companies or may be prepared according to methods described in U.S. Pat. No. 4,349,650 (Krespan) or European Patent 1,997,795 or by modifications thereof as known to a skilled person.

The amorphous fluoropolymers are derived predominantly or exclusively from perfluorinated comonomers including tetrafluoroethene (TFE) and one or more of the unsaturated perfluorinated alkyl ethers described above. “Predominantly” as used herein means at least 90% by weight based on the total weight of the fluoropolymer, of the polymerized units of the fluoropolymer are derived from such perfluorinated comonomers. In some embodiments the amorphous fluoropolymer comprises at least 91, 92, 93, 94, 95, 96, or 97% by weight or greater of such perfluorinated comonomers, based on the total weight of the fluoropolymer. The amorphous fluoropolymers may contain at least 40, 45, or 50% by weight of polymerized units derived from TFE. In some embodiments, the maximum amount of polymerized units derived from TFE is no greater than 60% by weight.

The amorphous fluoropolymer typically comprises polymerized units derived from one or more of the unsaturated perfluorinated alkyl ethers (such as PMVE, PAVE, PAAE or a combination thereof) in an amount of at least 10, 15, 20, 25, 30, 45, or 50% by weight, based on the total polymerized monomer units of the fluoropolymer. In some embodiments, the fluoropolymer comprises no greater than 50, 45, 40, or 35% by weight of polymerized units derived from one or more of the unsaturated perfluorinated alkyl ethers (such as PMVE, PAVE, PAAE or a combination thereof), based on the total polymerized monomer units of the fluoropolymer. The molar ratio of units derived from TFE to the perfluorinated alkly ethers described above may be, for example, from 1:1 to 5:1. In some embodiments, the molar ratio ranges from 1.5:1 to 3:1.

In other embodiments, the amorphous fluoropolymer comonomers comprise predominantly, or exclusively comprise, (e.g. repeating) polymerized units derived from two or more perfluorinated comonomers including tetrafluoroethene (TFE) and one or more unsaturated cyclic perfluorinated alkyl ethers, such as 2,2-bistrifluoromethyl-4,5-difluoro-1,3 dioxole. Such fluoropolymers are commercially available as “TEFLON™ AF”, “CYTOP™”, and “HYFLON™”.

As used herein, amorphous fluoropolymers are materials that contain essentially no crystallinity or possess no significant melting point as determined by the previously cited differential scanning calorimetry test method. Typically, amorphous fluoropolymers have a glass transition temperature (Tg) of less than 26° C., less than 20° C., or less than 0° C., and for example from −40° C. to 20° C., or −50° C. to 15° C., or −55° C. to 10° C. The amorphous fluoropolymers may typically have a Mooney viscosity (ML 1+10 at 121° C.) of from about 2 to about 150, for example from 10 to 100, or from 20 to 70. For amorphous polymers containing cyclic perfluorinated alky ether units, the glass transition temperature is typically at least 70° C., 80° C., or 90° C. and may range up to 220° C., 250° C., 270° C., or 290° C. The MFI (297° G/5 kg) is between 0, 1-1000 g/10 min.

The amorphous fluoropolymer is preferably a curable fluoropolymer that contains one or more cure-sites. Cure sites are functional groups that react in the presence of a curing agent or a curing system to cross-link the polymers. The cure sites are typically introduced by copolymerizing cure-site monomers, which are functional comonomers already containing the cure sites or precursors thereof. The cure sites react with an amine curing agent thereby crosslinking (curing) the fluoropolymer. One indication of crosslinking is that the dried and cured coating composition was not soluble in the fluorinated solvent of the coating.

The cure sites may be introduced into the polymer by using cure site monomers, i.e. functional monomers as will be described below, functional chain-transfer agents and starter molecules. The fluoroelastomers may contain cure sites that are reactive to more than one class of curing agents. An example widely used in the art includes cure sites containing nitrile or nitrile groups. Such cure sites are reactive, for example, to amine curing agent, as well as peroxide curing agents.

The curable fluoroelastomers may also contain cure sites in the back bone or as pending groups in addition or as an alternative to the cure sites at a terminal position. Cure sites within the fluoropolymer backbone can be introduced by using a suitable cure-site monomer. Cure site monomers are monomers containing one or more functional groups that can act as cure sites or contain a precursor that can be converted into a cure site.

In some embodiments, the cure sites comprise iodine or bromine atoms.

Iodine-containing cure site end groups can be introduced by using an iodine-containing chain transfer agent in the polymerization. Iodine-containing chain transfer agents will be described below in greater detail. Halogenated redox systems as described below may be used to introduce iodine end groups.

In addition to iodine cures sites, other cure sites may also be present, for example Br-containing cure sites or cure sites containing one or more nitrile groups. Br-containing cure sites may be introduced by Br-containing cure-site monomers. Nitrile-containing cure sites are typically introduced by cure site monomers containing a nitrile group.

Examples of cure-site comonomers include for instance:
(a) bromo- or iodo- (per)fluoroalkyl-(per)fluorovinylethers, for example including those having the formula:

ZRf—O—CX=CX₂

wherein each X may be the same or different and represents H or F, Z is Br or I, Rf is a C1-C12 (per)fluoroalkylene, optionally containing chlorine and/or ether oxygen atoms. Suitable examples include ZCF₂—O—CF═CF₂, ZCF₂CF₂—O—CF═CF₂, ZCF₂CF₂CF₂—O—CF═CF₂, CF₃CFZCF₂—O—CF═CF₂ or ZCF₂CF₂—O—CF₂CF₂CF₂—O—CF=CF₂ wherein Z represents Br of I; and
(b) bromo- or iodo perfluoroolefins such as those having the formula:

Z′—(Rf)r-CX═CX₂

wherein each X independently represents H or F, Z′ is Br or I, Rf is a C₁-C₁₂ perfluoroalkylene, optionally containing chlorine atoms and r is 0 or 1; and
(c) non-fluorinated bromo and iodo-olefins such as vinyl bromide, vinyl iodide, 4-bromo-1-butene and 4-iodo-1-butene.

Specific examples include but are not limited to compounds according to (b) wherein X is H, for example compounds with X being H and Rf being a C1 to C3 perfluoroalkylene. Particular examples include: bromo- or iodo-trifluoroethene, 4-bromo-perfluorobutene-1, 4-iodo-perfluorobutene-1, or bromo- or iodo-fluoroolefins such as 1-iodo,2,2-difluroroethene, 1-bromo-2,2-difluoroethene, 4-iodo-3,3,4,4,-tetrafluorobutene-1 and 4-bromo-3,3,4,4-tetrafluorobutene-1; 6-iodo-3,3,4,4,5,5,6,6-octafluorohexene-1.

Typically, the amount of iodine or bromine or their combination in the fluoropolymer is between 0.001 and 5%, preferably between 0.01 and 2.5%, or 0.1 to 1% or 0.2 to 0.6% by weight with respect to the total weight of the fluoropolymer. In one embodiment the curable fluoropolymers contain between 0.001 and 5%, preferably between 0.01 and 2.5%, or 0.1 to 1%, more preferably between 0.2 to 0.6% by weight of iodine based on the total weight of the fluoropolymer.

In some embodiments, the curable amorphous fluoropolymer contains nitrile-containing cure sites, as a alternative or in addition to the I- and/or Br-cure sites described above.

Nitrile-containing cure sites may be reactive to other cure systems for example, but not limited to, bisphenol curing systems, peroxide curing systems, triazine curing systems, and especially amine curing systems. Examples of nitrile containing cure site monomers correspond to the following formulae:

CF₂═CF—CF₂—O—R_{f}—CN;

CF₂═CFO(CF₂)ᵣCN;

CF₂═CFO[CF₂CF(CF₃)O]ₚ(CF₂)ᵥOCF(CF₃)CN;

CF₂═CF[OCF₂CF(CF₃)]ₖO(CF₂)ᵤCN;

wherein, r represents an integer of 2 to 12; p represents an integer of 0 to 4; k represents 1 or 2; v represents an integer of 0 to 6; u represents an integer of 1 to 6, R_{f} is a perfluoroalkylene or a bivalent perfluoroether group. Specific examples of nitrile containing fluorinated monomers include but are not limited to perfluoro (8-cyano-5-methyl-3,6-dioxa-1-octene), CF₂═CFO(CF₂)₅CN, and CF₂═CFO(CF₂)₃OCF(CF₃)CN.

The amount of units derived from nitrile-containing cure site comonomers depends on the desired crosslinking density. The amount of nitrile-containing cure site comonomer is typically at least 0.5, 1, 1.5, 2, 2.5, 3, 3.5, 4, 4.5 or 5% by weight and typically no greater than 10% by weight; based on the total weight of the fluoropolymer. The fluoropolymers may also be of dual cure type, containing different cure sites that are reactive to different curing systems. Fluoropolymers with nitrile-containing cure sites are known, such as described in U.S. Pat. No. 6,720,360.

It is contemplated that by using halogenated chain transfer agents terminal cure sites may be introduced. Chain transfer agents are compounds capable of reacting with the propagating polymer chain and terminating the chain propagation. Examples of chain transfer agents reported for the production of fluoroelastomers include those having the formula Rh, wherein R is an x-valent fluoroalkyl or fluoroalkylene radical having from 1 to 12 carbon atoms, which, may be interrupted by one or more ether oxygens and may also contain chlorine and/or bromine atoms. R may be Rf and Rf may be an x-valent (per)fluoroalkyl or (per)fluoroalkylene radical that may be interrupted once or more than once by an ether oxygen. Examples include alpha-omega diiodo alkanes, alpha-omega diiodo fluoroalkanes, and alpha-omega diiodoperfluoroalkanes, which may contain one or more catenary ether oxygens. “Alpha-omega” denotes that the iodine atoms are at the terminal positions of the molecules. Such compounds may be represented by the general formula X—R—Y with X and Y being I and R being as described above. Specific examples include di-iodomethane, alpha-omega (or 1,4-) diiodobutane, alpha-omega (or 1,3-) diiodopropane, alpha-omega (or 1,5-) diiodopentane, alpha-omega (or 1,6-) diiodohexane and 1,2-diiodoperfluoroethane. Other examples include fluorinated di-iodo ether compounds of the following formula:

R_{f}—CF(I)—(CX₂)ₙ—(CX₂CXR)ₘ—O—R″f-Oₖ—(CXR′CX₂)ₚ—(CX₂)_{q}—CF(I)—R′_{f}

wherein X is independently selected from F, H, and Cl; R_{f} and R′_{f} are independently selected from F and a monovalent perfluoroalkane having 1-3 carbons; R is F, or a partially fluorinated or perfluorinated alkane comprising 1-3 carbons; R″_{f} is a divalent fluoroalkylene having 1-5 carbons or a divalent fluorinated alkylene ether having 1-8 carbons and at least one ether linkage; k is 0 or 1; and n, m, and p are independently selected from an integer from 0-5, wherein, n plus m at least 1 and p plus q are at least 1.

The fluoropolymers may or may not contain units derived from at least one modifying monomer. The modifying monomers may introduce branching sites into the polymer architecture. Typically, the modifying monomers are bisolefins, bisolefinic ethers or polyethers. The bisolefins and bisolefinic (poly)ethers may be perfluorinated, partially fluorinated or non-fluorinated. Preferably they are perfluorinated. Suitable perfluorinated bisolefinic ethers include those represented by the general formula:

CF₂═CF—(CF₂)ₙ—O—(Rf)—O—(CF₂)ₘ—CF═CF₂

wherein n and m are independent from each other either 1 or 0 and wherein R_{f} represents a perfluorinated linear or branched, cyclic or acyclic aliphatic or aromatic hydrocarbon residue that may be interrupted by one or more oxygen atoms and comprising up to 30 carbon atoms. A particular suitable perfluorinated bisolefinic ether is a di-vinylether represented by the formula:

CF₂═CF—O—(CF₂)ₙ—O—CF═CF₂

wherein n is an integer between 1 and 10, preferably 2 to 6., e.g. n may be 1, 2, 3, 4, 5, 6 or 7. More preferably, n represents an uneven integer, for example 1, 3, 5 or 7.

Further specific examples include bisolefinic ethers according the general formula

CF₂═CF—(CF₂)ₙ—O—(CF₂)ₚ—O—(CF₂)ₘ—CF═CF₂

wherein n and m are independently either 1 or 0 and p is an integer from 1 to 10 or 2 to 6. For example n may be selected to represent 1, 2, 3, 4, 5, 6 or 7, preferably, 1, 3, 5 or 7.

Further suitable perfluorinated bisolefinic ethers can be represented by the formula

CF₂═CF—(CF₂)ₚ—O—(R_{af}O)ₙ(R_{bf}O)ₘ—(CF₂)_{q}—CF═CF₂

wherein R_{af} and R_{bf} are different linear or branched perfluoroalkylene groups of 1-10 carbon atoms, in particular 2 to 6 carbon atoms, and which may or may not be interrupted by one or more oxygen atoms. R_{af} and/or R_{bf} may also be perfluorinated phenyl or substituted phenyl groups; n is an integer between 1 and 10 and m is an integer between 0 and 10, preferably m is 0. Further, p and q are independent from each other either 1 or 0.

Such modifiers can be prepared by methods known in the art and are commercially available, for example, from Anles Ltd, St. Petersburg, Russia.

Preferably, the modifiers are not used or only used in low amounts. Typical amounts include from 0 to 5%, or from 0 to 1.4% by weight based on the total weight of the fluoropolymer. Modifiers may be are present, for example, in amounts from about 0.1% to about 1.2% or from about 0.3% to about 0.8% by weight based on the total weight of fluoropolymer.

Combinations of modifiers may also be used.

The fluoropolymers may contain partially fluorinated or non-fluorinated comonomers and combinations thereof, although this is not preferred. Typical partially fluorinated comonomers include but are not limited to 1,1-difluoroethene (vinylidenefluoride, VDF) and vinyl fluoride (VF) or trifluorochloroethene or trichlorofluoroethene. Examples of non-fluorinated comonomers include but are not limited to ethene and propene. The amounts of units derived from these comonomers include from 0 to 8% by weight based on the total weight of the fluoropolymer. In some embodiments, the concentration of such comonomer is no greater than 7, 6, 5, 4, 3, 2, or 1% by weight based on the total weight of the fluoropolymer.

In a preferred embodiment the curable fluoropolymer is a perfluoroelastomer that comprises repeating units (exclusivel)y derived from the perfluorinated comonomers but may contain units derived from cure-site monomers, and modifying monomers if desired. The cure-site monomers and modifying monomers may be partially fluorinated, not fluorinated or perfluorinated and preferably are perfluorinated. The perfluoroelastomers may contain from 69 to 73, 74, or 75% fluorine by weight (based on the total amount of perfluoroelastomer). The fluorine content may be achieved by selecting the comonomers and their amounts accordingly.

Such highly-fluorinated amorphous fluoropolymers typically do not dissolve to the extent of at least 1 wt. %, at room temperature and standard pressure, in a hydrogen-containing organic liquid (e.g., it does not dissolve in any of methyl ethyl ketone (“MEK”), tetrahydrofuran (“THF”), ethyl acetate or N-methyl pyrrolidinone (“NMP”)).

As evident by Table 3 of the forthcoming examples, when the amorphous fluoropolymer alone (i.e. without the dispersed crystalline fluoropolymer particles) is heated to temperatures of 150, 200, or 300° C., the amorphous fluoropolymer remains soluble in fluorinated (e.g. HFE-7500) solvent. However, when the amorphous fluoropolymer together with the dispersed crystalline fluoropolymer particles is heated to temperatures of 200 or 300° C., the composition becomes insoluble in fluorinated (e.g. HFE-7500) solvent. Without intending to be bound by theory, it is surmised that the TFE units of the crystalline fluoropolymer particles co-crystallize with the TFE units of the amorphous fluoropolymer, thereby crosslinking the amorphous fluoropolymer.

The fluoropolymer compositions described herein optionally contain one or more curing agents such as an amine curing agent.

Suitable curing agents for nitrile cure sites are known in the art and include, but are not limited to amidines, amidoximes and others described in WO2008/094758 A1, incorporated herein by reference. Such curing agents include nitrogen-containing nucleophilic compounds selected from heterocyclic secondary amines; guanidines; compounds which decompose in-situ at a temperature between 40° C. and 330° C. to produce a guanidine; compounds which decompose in-situ at a temperature between 40° C. and 330° C. to produce a primary or secondary amine; nucleophilic compounds of the formula R₁—NH—R₂, wherein R₁ is H—, a C₁-C₁₀ aliphatic hydrocarbon group, or an aryl group having hydrogen atoms in the alpha positions, R₂ is a C₁-C₁₀ aliphatic hydrocarbon group, an aryl group having hydrogen atoms in the alpha positions, —CONHR₃, —NHCO₂R₃, or —OH′, and R₃ is a C₁-C₁₀ aliphatic hydrocarbon group; and substituted amidines of the formula HN═CR₄NR₅R₆, wherein R₄, R₅, R₆ are independently H—, alkyl or aryl groups and wherein at least one of R₄, R₅ and Re is not H—.

As used herein, “heterocyclic secondary amine” refers to aromatic or aliphatic cyclic compound having at least one secondary amine nitrogen contained within the ring. Such compounds include, for example, pyrrole, imidazole, pyrazole, 3-pyrroline, and pyrrolidine.

Guanidines included in this disclosure are compounds derived from guanidine, i.e. compounds which contain the radical. —NHCNHNH—, such as, but not limited to, diphenylguanidine, diphenylguanidine acetate, aminobutylguanidine, biguanidine, isopentylguanidine, di-σ-tolylguanidine, o-tolylbiguanide, and triphenylguanidine.

In some embodiments, the curing agent is a compound that decomposes in-situ at a temperature between 40° C. and 330° C. to produce either a primary or secondary amine include, but are not limited to, di- or poly-substituted ureas (e.g. 1,3-dimethyl urea); N-alkyl or -dialkyl carbamates (e.g. N-(tert-butyloxycarbonyl)propylamine); di- or poly-substituted thioureas (e.g. 1,3-dimethyl-thiourea); aldehyde-amine condensation products (e.g. 1,3,5-trimethylhexahydro-1,3,5-triazine) N,N′-dialkyl phthalamide derivatives (e.g. N,N′-dimethylphthalamide): and amino acids.

Illustrative examples of nucleophilic compounds of formula R₁—NH—R₂ include, but are not limited to, aniline, t-butylcarbazate and C₁-C₁₀ aliphatic primary amines (such as methylamine). Illustrative examples of substituted amidines of the formula HN═CR₄NR₅R₆ include benzamidine and N-phenylbenzamidine.

In another embodiment, the amine curing agent is an aromatic or aliphatic cyclic compound having at least one tertiary amine nitrogen contained within the ring, or in other words a “heterocyclic tertiary amine”. One such compound is 1,8-diazabicyclo[5.4.0] unde-7-ene.

It is surmised that most of these nucleophilic compounds act as curing agents by catalyzing the trimerization of polymer chain bound nitrile groups to form triazine rings, thus crosslinking the fluoroelastomer.

Another type of amine curing agent includes bis(aminophenols) and bis(aminothiophenols) of the formulae

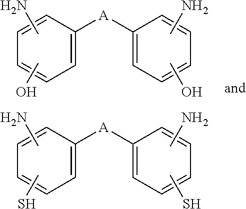

and tetraamines of the formula

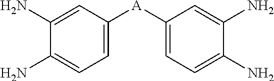

where A is SO₂, O, CO, alkyl of 1-6 carbon atoms, perfluoroalkyl of 1-10 carbon atoms, or a carbon-carbon bond linking the two aromatic rings. The amino and hydroxyl groups in the above formulas are interchangeably in the meta and para positions with respect to group A. Preferably, the second curing agent is a compound selected from the group consisting of 2,2-bis[3-amino-4-hydroxyphenyl]hexafluoropropane; 4,4′-sulfonylbis(2-aminophenol); 3,3′-diaminobenzidine; and 3,3′,4,4′-tetraaminobenzophenone. The first of these curing agents are referred to as diaminobisphenol AF. The curing agents can be prepared as disclosed in U.S. Pat. No. 3,332,907 to Angelo. Diaminobisphenol AF can be prepared by nitration of 4,4′-[2,2,2-trifluoro-1-(trifluoromethyl)ethylidene]bisphenol (i.e. bisphenol AF), preferably with potassium nitrate and trifluoroacetic acid, followed by catalytic hydrogenation, preferably with ethanol as a solvent and a catalytic amount of palladium on carbon as catalyst.

In some embodiments, the (e.g. bis(aminophenols) and bis(aminothiophenols) are used in combination with an organotin compound. Suitable organotin compounds include allyl-, propargyl-, triphenyl- and allenyl tin curatives.

In some embodiments, the amine curing agent is an aziridine compound.

In some embodiments, the aziridine compound comprises at least two aziridine groups. The aziridine compound may comprise 3, 4, 5, 6, or greater than 6 aziridine groups. The aziridine compound may be represented by the following structure:

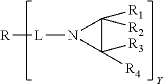

wherein R is a core moiety having a valency of Y;
L is a bond, divalent atom, or divalent linking group;
R₁, R₂, R₃, and R₄ are independently hydrogen or a C₁-C₄ alkyl (e.g. methyl); and
Y is typically 2, 3, or greater.

In some embodiments, R is —SO₂—. In some embodiments, R-L is a residue of a multi(meth)acrylate compound. In some embodiments L is a C₁-C₄ alkylene, optionally substituted with one or more (e.g. contiguous or pendant) oxygen atoms thereby forming ether or ester linkages. In typical embodiments, R₁ is methyl and R₂, R₃, and R₄ are hydrogen.

Representative aziridine compounds include trimethylolpropane tri-[beta-(N-aziridinyl)-propionate, 2,2-bishydroxymethyl butanoltris[3-(1-aziridine) propionate]; 1-(aziridin-2-yl)-2-oxabut-3-ene; and 4-(aziridin-2-yl)-but-1-ene; and 5-(aziridin-2-yl)-pent-1-ene.

In some embodiments, a polyaziridine compound can be prepared by reacting divinyl sulfone with alkylene (e.g. ethylene) imine, such as described in U.S. Pat. No. 3,235,544(Christena). On representative compound is di(2-propyleniminoethyl)sulfone, as depicted as follows:

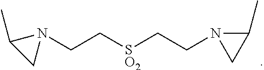

The above described polyaziridine compounds comprise at least two aziridine groups at the time the compound is added to the coating composition. In other embodiments, the polyaziridine compound does not comprise two aziridine groups at the time the compound is added to the coating composition, yet forms a polyaziridine in-situ. For example, compounds comprising a single aziridine group and a single (meth)acrylate group can form a dimer or oligomerize by reaction of the (meth)acrylate groups thereby forming a polyazirdine (i.e. diaziridine) compound.

In some favored embodiments, the composition comprises a compound comprising at least one (e.g. primary, secondary tertiary) amine group and at least one organosilane (e.g. alkoxy silane) group. Such compounds can improve bonding in combination with crosslinking certain fluoroelastomers.

In some embodiments, the amine curing agent may be characterized as an amino-substituted organosilane ester or ester equivalent that bear on the silicon atom at least one, and preferably 2 or 3 ester or ester equivalent groups. Ester equivalents are known to those skilled in the art and include compounds such as silane amides (RNR′Si), silane alkanoates (RC(O)OSi), Si—O—Si, SiN(R)—Si, SiSR and RCONR′Si compounds that are thermally and/or catalytically displaceable by R″OH. R and R′ are independently chosen and can include hydrogen, alkyl, arylalkyl, alkenyl, alkynyl, cycloalkyl, and substituted analogs such as alkoxyalkyl, aminoalkyl, and alkylaminoalkyl. R″ may be the same as R and R′ except it may not be H. These ester equivalents may also be cyclic such as those derived from ethylene glycol, ethanolamine, ethylenediamine and their amides.

Another such cyclic example of an ester equivalent is

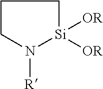

In this cyclic example R′ is as defined in the preceding sentence except that it may not be aryl. 3-aminopropyl alkoxysilanes are well known to cyclize upon heating and these RNHSi compounds would be useful in this invention. Preferably the amino-substituted organosilane ester or ester equivalent has ester groups such as methoxy that are easily volatilized as methanol. The amino-substituted organosilane must have at least one ester equivalent; for example, it may be a trialkoxysilane.

For example, the amino-substituted organosilane may have the formula (Z₂N-L-SiX′X″X′″), wherein

Z is hydrogen, alkyl, or substituted aryl or alkyl including amino-substituted alkyl; and L is a divalent straight chain C1-12 alkylene or may comprise a C3-8 cycloalkylene, 3-8 membered ring heterocycloalkylene, C2-12 alkenylene, C4-8 cycloalkenylene, 3-8 membered ring heterocycloalkenylene or heteroarylene unit; and each of X′, X″ and X′″ is a C1-18 alkyl, halogen, C1-8 alkoxy, C1-8 alkylcarbonyloxy, or amino group, with the proviso that at least one of X′, X″, and X′″ is a labile group. Further, any two or all of X′, X″ and X′″ may be joined through a covalent bond. The amino group may be an alkylamino group.

L may be divalent aromatic or may be interrupted by one or more divalent aromatic groups or heteroatomic groups. The aromatic group may include a heteroaromatic. The heteroatom is preferably nitrogen, sulfur or oxygen. L is optionally substituted with C1-4 alkyl, C2-4 alkenyl, C2-4 alkynyl, C1-4 alkoxy, amino, C3-6 cycloalkyl, 3-6 membered heterocycloalkyl, monocyclic aryl, 5-6 membered ring heteroaryl, C1-4 alkylcarbonyloxy, C1-4 alkyloxycarbonyl, C1-4 alkylcarbonyl, formyl, C1-4 alkylcarbonylamino, or C1-4 aminocarbonyl. L is further optionally interrupted by —O—, —S—, —N(Rc)-, —N(Rc)-C(O)—, —N(Rc)-C(O)—O—, —O—C(O)—N(Rc)-, —N(Rc)-C(O)—N(Rd)-, —O—C(O)—, —C(O)—O—, or —O—C(O)-O—. Each of Rc and Rd, independently, is hydrogen, alkyl, alkenyl, alkynyl, alkoxyalkyl, aminoalkyl (primary, secondary or tertiary), or haloalkyl.

Examples of amino-substituted organosilanes include 3-aminopropyltrimethoxysilane (SILQUEST A-1110), 3-aminopropyltriethoxysilane (SILQUEST A-1100), bis(3-trimethoxysilylpropy)amine, 3-(2-aminoethyl)aminopropyltrimethoxysilane (SILQUEST A-1120), SILQUEST A-1130, (aminoethylaminomethyl)phenethyltrimethoxysilane, (aminoethylaminomethyl)-phenethyltriethoxysilane, N-(2-aminoethyl)-3-aminopropylmethyldimethoxysilane (SILQUEST A-2120), bis-(.gamma.-triethoxysilylpropyl)aine (SILQUEST A-1170), N-(2-aminoethyl)-3-aminopropyltributoxysilane, 6-(aminohexylaminopropyl)trimethoxysilane, 4-aminobutyltrimethoxysilane, 4-aminobutyltriethoxysilane, p-(2-aminoethyl)phenyltrimethoxysilane, 3-aminopropyltris(methoxyethoxyethoxy)silane, 3-aminopropylmethyldiethoxy-silane, oligomeric aminosilanes such as DYNASYLAN 1146, 3-(N-methylamino)propyltrimethoxysilane, N-(2-aminoethyl)-3-aminopropylme-thyldimethoxysilane, N-(2-aminoethyl)-3-aminopropylmethyldiethoxysilane, N-(2-aminoethyl)-3-aminopropyltrimethoxysilane, N-(2-aminoethyl)-3-aminopropyltriethoxysilane, 3-aminopropylmethyldiethoxysilane, 3-aminopropylmethyldimethoxysilane, 3-aminopropyldimethylmethoxysilane, 3-aminopropyldimethylethoxysilane, and the following cyclic compounds:

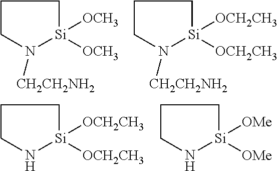

A bis-silyl urea [RO)₃Si(CH₂)NR]₂C═O is another example of an amino-substituted organosilane ester or ester equivalent.

In some embodiments, the curing agent may comprise an amino group having latent functionality.

One example of such curing agent is a blocked amine group, such as

R³—N═C(R¹)(R²)

wherein R¹ and R² are independently selected from a linear or branched alkyl group comprising 1 to 6 carbon atoms. In typical embodiments R1 is methyl, and R² a linear or branched alkyl group comprising at least 2, 3, 4, 5, or 6 carbon atoms. R³ is typically an organic group (e.g. having a molecular weight less than 500, 450, 400, 350, 300, or 250 g/mole). The blocked amine can be activated by moisture provided by water adsorbed on the surface of the substrate being coated or from humidity. Deblocking begins in minutes and is generally complete within a few (e.g. two) hours. During deblocking the —N═C(R¹)R²) group is converted to —NH₂ that can then react with the (e.g. nitrile cure sites) of the fluoropolymer.

In some embodiments, the curing agent comprises a blocked amine group and an alkoxy silane group. Such blocked amine curing agent can be characterized by the following general formula:

(R⁴O)₃—Si—(CH₂)ₘ—N═C(R1)(R2)

wherein R¹ and R² are independently selected from a linear or branched alkyl group comprising 1 to 6 carbon atoms as previously described
R¹ is independently selected from a linear or branched alkyl group comprising 1 to 6 carbon atoms, m is an integer from 1 to 4, and each R⁴ is independently a C1 or C2 alkyl group.

One illustrative curing agent comprising a blocked amine group and an alkoxy silane group is N-(1,3-dimethylbutylidene)aminopropyl-triethoxysilane, depicted as follows:

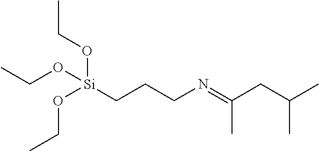 [SMILES: CCO[Si](CCC/N=C(\C)CC(C)C)(OCC)OCC]

Such curing agent is available from Gelest and from 3M as “3M™Dynamer™ Rubber Curative RC5125”.

In some embodiments, the amine curing agent comprises an aziridine group and an alkoxy silane group. Such compounds are known for examples from U.S. Pat. No. 3,243,429; incorporated herein by reference. Aziridine alkoxy silane compounds may have the general structure:

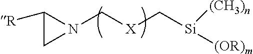

wherein R″ is hydrogen or a C₁-C₄ alkyl (e.g. methyl);
X is a bond, a divalent atom, or a divalent linking group;
n is 0, 1 or 2;
m is 1, 2, or 3; and
and the sum or n+m is 3.

One representative compound is 3-(2-methylaziridinyl) ethylcarboxylpropyltriethoxysilane.

Various other suitable aziridine crosslinkers are known, such as described in WO2014/075246; published May 22, 2014, incorporated herein by reference; and “NEW GENERATION OF MULTIFUNCTIONAL CROSSLINKERS” (See https://www.pstc.org/files/public/Milker00.pdf).

A single amine (e.g. curing agent) compound may be used or a combination of amine (e.g. curing agent) compounds may be used. Thus, amine curing agent may be the sole curing agents. In this embodiment, the composition is free of multi-olefinic crosslinkers including perfluoropolyether multi-(meth)acrylate derivatives of “HFPO”, as described in US 2006/0147723 (Jing, et al); incorporated herein by reference. Alternatively, the fluoropolymer composition may comprise such multi-olefinic crosslinkers including perfluoropolyether multi-(meth)acrylate derivatives of “HFPO”.

The amount of amine (e.g. curing agent) is typically at least 0.01, 0.02, 0.03, 0.04, 0.05, 0.06, 0.07, 0.08, 0.09, 0.1, 0.2, 0.3, 0.4, or 0.5% by weight solids (i.e. excluding the solvent of the coating composition). In some embodiments, the amount of amine (e.g. curing agent) compound is no greater than 5, 4.5, 4, 3.5, or 3% by weight solids.

An appropriate level of curing agents can be selected by considering cure properties, for example the time to develop maximum moving die rheometer (MDR) torque and minimum Mooney scorch of the curable compositions. The optimum level will depend on the particular combination of fluoropolymer and curing agent and the desired properties of the cured elastomer.

In some embodiments, the fluoropolymer composition comprises an (e.g. amine) curing agent in combination with an alkoxy silane compound that lacks amine functionality. In some embodiments, such alkoxy silanes may be characterized as “non-functional” having the chemical formula:

R²Si(OR¹)ₘ

wherein R¹ is independently alkyl as previously described;
R² is independently hydrogen, alkyl, aryl, alkaryl, or O R¹; and
m ranges from 1 to 3, and is typically 2 or 3 as previously described.

Suitable alkoxy silanes of the formula R²Si(OR′)ₘ include, but are not limited to tetra-, tri- or dialkoxy silanes, and any combinations or mixtures thereof. Representative alkoxy silanes include propyltrimethoxysilane, propyltriethoxysilane, butyltrimethoxysilane, butyltriethoxysilane, pentyltrimethoxysilane, pentyltriethoxysilane, heptyltrimethoxysilane, heptyltriethoxysilane, octyltrimethoxysilane, octyltriethoxysilane, dodecyltrimethoxysilane, dodecyltriethoxysilane, hexadecyltrimethoxysilane, hexadecyltriethoxysilane, octadecyltrimethoxysilane, octadecyltriethoxysilane, phenyltrimethoxysilane, phenyltriethoxysilane dimethyldimethoxysilane and dimethyldiethoxysilane.

Preferably, the alkyl group(s) of the alkoxy silanes comprises from 1 to 6, more preferably 1 to 4 carbon atoms. Preferred alkoxysilanes for use herein are selected from the group consisting of tetra methoxysilane, tetra ethoxysilane, methyl triethoxysilane, dimethyldiethoxysilane, and any mixtures thereof. A preferred alkoxysilane for use herein comprises tetraethoxysilane (TEOS). The alkoxy silane lacking organofunctional groups utilized in the method of making the coating composition may be partially hydrolyzed, such as in the case of partially hydrolyzed tetramethoxysilane (TMOS) available from Mitsuibishi Chemical Company under the trade designation “MS-51”.

When present, the amount of alkoxy silane compound that lacks functionality (e.g. TESO) is typically at least 0.01, 0.02, 0.03, 0.04, 0.05, 0.06, 0.07, 0.08, 0.09, 0.1, 0.2, 0.3, 0.4, or 0.5% by weight solids (i.e. excluding the solvent of the coating composition). In some embodiments, the amount of alkoxy silane compound that lacks functionality is no greater than 5, 4.5, 4, 3.5, or 3% by weight solids.

In some embodiments, a non-amine curing agent may be used. In some embodiments, an amine (e.g. curing agent) compound may be used in combination with a non-amine curing agent.

When present, the amount of non-amine curing agent is typically at least 0.01, 0.02, 0.03, 0.04, 0.05, 0.06, 0.07, 0.08, 0.09, 0.1, 0.2, 0.3, 0.4, or 0.5% by weight solids (i.e. excluding the solvent of the coating composition). In some embodiments, the amount of non-amine curing agent is no greater than 5, 4.5, 4, 3.5, or 3% by weight solids.

In one embodiments, the non-amine curing agent is an alkoxy silane that comprises other functional groups, such as in the case of 3-mercaptopropyl trimethoxysilane.

In other embodiments, the composition further comprises an organic peroxide, as a second curing agent. The peroxide will cause curing of the fluorinated polymer to form a cross-linked (cured) fluoropolymer when activated. Suitable organic peroxides are those which generate free radicals at curing temperatures. Examples include dialkyl peroxides or bis(dialkyl peroxides), for example. a di-tertiarybutyl peroxide having a tertiary carbon atom attached to the peroxy oxygen. Specific examples include 2,5-dimethyl-2,5-di(tertiarybutylperoxy)hexyne-3 and 2,5-dimethyl-2,5-di(tertiarybutylperoxy)hexane; dicumyl peroxide, dibenzoyl peroxide, tertiarybutyl perbenzoate, alpha,alpha′-bis(t-butylperoxy-diisopropylbenzene), and di[1,3-dimethyl-3-(t-butylperoxy)-butyl]carbonate. Generally, about 1 to 5 parts of peroxide per 100 parts of fluoropolymer may be used.

The curing agents may also be present on carriers, for example silica containing carriers. A peroxide cure system may also include in addition one or more coagent. Typically, the coagent includes a polyunsaturated compound which is capable of cooperating with the peroxide to provide a useful cure. These coagents may typically be added in an amount between 0.1 and 10 parts per hundred parts fluoropolymer, preferably between 2 and 5 parts per hundred parts fluoropolymer. Examples of useful coagents include triallyl cyanurate; triallyl isocyanurate; triallyl trimellitate; tri(methylallyl)isocyanurate; tris(diallylamine)-s-triazine; triallyl phosphite; (N,N′)-diallyl acrylamide; hexaallyl phosphoramide; (N,N,N,N)-tetraalkyl tetraphthalamide; (N,N,N′,N-tetraallylmalonamide; trivinyl isocyanurate; 2,4,6-trivinyl methyltrisiloxane; N,N′-m-phenylenebismaleimide; diallyl-phthalate and tri(5-norbomene-2-methylene)cyanurate. Particularly useful is triallyl isocyanurate.

In some embodiments, the fluoropolymer composition may also be cured using actinic irradiation, for example but not limited to e-beam curing, allowing for dual cure systems.

The fluoropolymer (coating solution) compositions comprises at least one solvent. The solvent is capable of dissolving the fluoropolymer. The solvent is typically present in an amount of at least 25% by weight based on the total weight of the coating solution composition. In some embodiment, the solvent is present in an amount of at least 30, 35, 40, 45, 50, 55, 60, 65, 70, 75, 80, 85, 90, 95% or greater based on the total weight of the coating solution composition.

The fluoropolymer (coating solution) composition typically comprises at least 0.01, 0.02, 0.03, 0.03, 0.04, 0.04, 0.05, 0.06, 0.7, 0.8.0.9 or 1% by weight of fluoropolymer, based on the weight of the total coating solution composition. In some embodiments, the fluoropolymer coating solution composition comprises at least 2, 3, 4, or 5% by weight of fluoropolymer. In some embodiments, the fluoropolymer coating solution composition comprises at least 6, 7, 8, 9 or 10% by weight of fluoropolymer. The fluoropolymer coating solution composition typically comprises no greater than 50, 45, 40, 35, 30, 25, or 20% by weight of fluoropolymer, based on the weight of the total coating solution composition.

Optimum amounts of solvent and fluoropolymers may depend on the final application and may vary. For example, to provide thin coatings, very dilute solutions of fluoropolymer in the solvent may be desired, for example amounts of from 0.01% by weight to 5% by weight of fluoropolymer. Also for application by spray coating composition of low viscosity may be preferred over solutions with high viscosity. The concentration of fluoropolymer in the solution affects the viscosity and may be adjusted accordingly. An advantage of the present disclosure is that also solutions with high concentrations of fluoropolymer can be prepared that still provide clear liquid composition of low viscosity.

In some embodiments, the fluoropolymer coating solution compositions may be liquids. The liquids may have, for example, a viscosity of less than 2,000 mPas at room temperature (20° C.+/−2° C.). In other embodiments, the fluoropolymer coating solution compositions are pastes. The pastes may have, for example, a viscosity of from 2,000 to 100.000 mPas at room temperature (20° C.+/−2° C.). The solvent is a liquid at ambient conditions and typically has a boiling point of greater than 50° C. Preferably, the solvent has a boiling point below 200° C. so that it can be easily removed. In some embodiments, the solvent has a boiling point below 190, 180, 170, 160, 150, 140, 130, 120, 110, or 100° C. The solvent is partially fluorinated or perfluorinated. Various partially fluorinated or perfluorinated solvents are known including perfluorocarbons (PFCs), hydrochlorofluorocarbons (HCFCs), perfluoropolyethers (PFPEs), and hydrofluorocarbons (HFCs), as well as fluorinated ketones and fluorinated alkyl amines.

In some embodiments, the solvent has a global warming potential (GWP, 100 year ITH) of less than 1000, 900, 800, 700, 600, 500, 400, 300, 200 or 100. The GWP is typically greater than 0 and may be at least 10, 20, 30, 40, 50, 60, 70, or 80.

As used herein, GWP is a relative measure of the global warming potential of a compound based on the structure of the compound. The GWP of a compound, as defined by the Intergovernmental Panel on Climate Change (IPCC) in 1990 and updated in subsequent reports, is calculated as the warming due to the release of 1 kilogram of a compound relative to the warming due to the release of 1 kilogram of CO₂ over a specified integration time horizon (ITH).

$${GWP}_{x} = \frac{{\int }_{0}^{ITH} {F}_{x} {C}_{xo} exp ( - t / {τ}_{x} ) dt}{{\int }_{0}^{ITH} {F}_{CO 2} {C}_{CO 2} ( t ) dt}$$

where F is the radiative forcing per unit mass of a compound (the change in the flux of radiation through the atmosphere due to the IR absorbance of that compound), Cₒ is the atmospheric concentration of a compound at initial time, τ is the atmospheric lifetime of a compound, t is time, and x is the compound of interest.

In some embodiments, the solvent comprises a partially fluorinated ether or a partially fluorinated polyether. The partially fluorinated ether or polyether may be linear, cyclic or branched. Preferably, it is branched. Preferably it comprises a non-fluorinated alkyl group and a perfluorinated alkyl group and more preferably, the perfluorinated alkyl group is branched.

In one embodiment, the partially fluorinated ether or polyether solvent corresponds to the formula:

Rf—O—R

wherein Rf is a perfluorinated or partially fluorinated alkyl group that may be interrupted once or more than once by an ether oxygen and R is a non-fluorinated or partially fluorinated alkyl group. Typically, Rf may have from 1 to 12 carbon atoms. Rf may be a primary, secondary or tertiary fluorinated or perfluorinated alkyl residue. This means, when Rf is a primary alkyl residue the carbon atom linked to the ether atoms contains two fluorine atoms and is bonded to another carbon atom of the fluorinated or perfluorinated alkyl chain. In such case Rf would correspond to R_{f}¹—CF₂— and the polyether can be described by the general formula: R_{f}¹—CF₂—O—R.

When Rf is a secondary alkyl residue, the carbon atom linked to the ether atom is also linked to one fluorine atoms and to two carbon atoms of partially and/or perfluorinated alkyl chains and Rf corresponds to (R_{f}²R_{f}³)CF—. The polyether would correspond to (R_{f}²R_{f}³)CF—O—R.

When Rf is a tertiary alkyl residue the carbon atom linked to the ether atom is also linked to three carbon atoms of three partially and/or perfluorinated alkyl chains and Rf corresponds to (R_{f}⁴R_{f}⁵R_{f}⁶)—C—. The polyether then corresponds to (R_{f}⁴R_{f}⁵R_{f}⁶)—C—OR. R_{f}¹; R_{f}²; R_{f}³; R_{f}⁴; R_{f}⁵; R_{f}⁶ correspond to the definition of Rf and are a perfluorinated or partially fluorinated alkyl group that may be interrupted once or more than once by an ether oxygen. They may be linear or branched or cyclic. Also a combination of polyethers may be used and also a combination of primary, secondary and/or tertiary alkyl residues may be used.

An example of a solvent wherein Rf is a partially fluorinated alkyl group includes C₃F₇OCHFCF₃ (CAS No. 3330-15-2).

An example of a solvent wherein Rf is a polyether is C₃F₇OCF(CF₃)CF₂OCHFCF₃ (CAS No. 3330-14-1).

In some embodiments, the partially fluorinated ether solvent corresponds to the formula:

CpF2p+1-O—CqH2q+1

wherein q is an integer from 1 to and 5, for example 1, 2, 3, 4 or 5, and p is an integer from 5 to 11, for example 5, 6, 7, 8, 9, 10 or 11. Preferably, CₚF₂ₚ₊₁ is branched. Preferably, CₚF₂ₚ₊₁ is branched and q is 1, 2 or 3.

Representative solvents include for example 1,1,1,2,2,3,4,5,5,5-decafluoro-3-methoxy-4-(trifluoromethyl)pentane and 3-ethoxy-1,1,1,2,3,4,4,5,5,6,6,6-dodecafluroro-2-(trifluoromethyl)hexane. Such solvents are commercially available, for example, under the trade designation NOVEC from 3M Company, St. Paul, Minn.

The fluorinated (e.g. ethers and polyethers) solvents may be used alone or in combination with other solvents, which may be fluorochemical solvents or non-fluorochemical solvents. When a non-fluorochemical solvent is combined with a fluorinated solvent, the concentration non-fluorochemical solvent is typically less than 30, 25, 20, 15, 10 or 5 wt. % with respect to the total amount of solvent. Representative non-fluorochemical solvents include ketones such as acetone, MEK, methyl isobutyl ketone, methyl amyl ketone and NMP; ethers such as tetrahydrofuran, 2-methyl tetrahydrofuran and methyl tetrahydrofirfuyl ether; esters such as methyl acetate, ethyl acetate and butyl acetate; cyclic esters such as delta-valerolactone and gamma-valerolactone.

Compositions containing curable fluoroelastomers may further contain additives as known in the art. Examples include acid acceptors. Such acid acceptors can be inorganic or blends of inorganic and organic acid acceptors. Examples of inorganic acceptors include magnesium oxide, lead oxide, calcium oxide, calcium hydroxide, dibasic lead phosphate, zinc oxide, barium carbonate, strontium hydroxide, calcium carbonate, hydrotalcite, etc. Organic acceptors include epoxies, sodium stearate, and magnesium oxalate. Particularly suitable acid acceptors include magnesium oxide and zinc oxide. Blends of acid acceptors may be used as well. The amount of acid acceptor will generally depend on the nature of the acid acceptor used. Typically, the amount of acid acceptor used is between 0.5 and 5 parts per 100 parts of fluorinated polymer.

The fluoropolymer composition may contain further additives, such as stabilizers, surfactants, ultraviolet (“UV”) absorbers, antioxidants, plasticizers, lubricants, fillers, and processing aids typically utilized in fluoropolymer processing or compounding, provided they have adequate stability for the intended service conditions. A particular example of additives includes carbon particles, like carbon black, graphite, soot. Further additives include but are not limited to pigments, for example iron oxides, titanium dioxides. Other additives include but are not limited to clay, silicon dioxide, barium sulphate, silica, glass fibers, or other additives known and used in the art.

The fluoropolymer compositions may be prepared by mixing the polymer, the curing agent(s) including at least one amine curing agent, optional additives and the fluorinated solvent. In some embodiments, the fluoropolymer is first dissolved in the fluorinated solvent and the other additives, including the curing agent(s) are added thereafter.

The coating composition described herein including fluorinated solvent is “stable, meaning that the coating composition remains homogeneous when stored for at least 24 hours at room temperature in a sealed container. In some embodiments, the coating composition is stable for one week or more. “Homogeneous” refers to a coating composition that does not exhibit a visibly separate precipitate or visibly separate layer when freshly shaken, placed in a 100 ml glass container and allowed to stand at room temperature for at least 4 hours.

In some embodiments, the fluoropolymer is first combined with other solid ingredients and in particular with the amine(s) described herein. The fluoropolymer and amine compounds can be combined in conventional rubber processing equipment to provide a solid mixture, i.e. a solid polymer containing the additional ingredients, also referred to in the art as a “compound”. Typical equipment includes rubber mills, internal mixers, such as Banbury mixers, and mixing extruders. During mixing the components and additives (including the amine curing agent) are distributed uniformly throughout the resulting fluorinated polymer “compound” or polymer sheets. The compound is then preferably comminuted, for example by cutting it into smaller pieces and is then dissolved in the solvent.

The fluoropolymer coating solution compositions provided herein are suitable for coating substrates. The fluoropolymer coating solution compositions may be formulated to have different viscosities depending on solvent and fluoropolymer content and the presence or absence of optional additives. The fluoropolymer coating solution compositions typically contain or are solutions of fluoropolymers and may be in the form of liquids or pastes. Nevertheless, the compositions may contain dispersed or suspended materials but these materials preferably are additives and not fluoropolymers of the type as described herein. Preferably, the compositions are liquids and more preferably they are solutions containing one or more fluoropolymer as described herein dissolved in a solvent as described herein.

The fluoropolymer compositions provided herein are suitable for coating substrates and may be adjusted (by the solvent content) to a viscosity to allow application by different coating methods, including, but not limited to spray coating or printing (for example but not limited to ink-printing, 3D-printing, screen printing), painting, impregnating, roller coating, bar coating, dip coating and solvent casting.

Coated substrates and articles may be prepared by applying the fluoropolymer compositions to a substrate and removing the solvent. In some embodiments, an amorphous fluoropolymer coating lacking crystalline fluoropolymer particles is applied to the fluoropolymer compositions described herein. The layer of amorphous fluoropolymer lacking crystalline fluoropolymer particles may have a thickness of at least 1, 1.5, or 2 mils ranging up to 5, 6, 7, 8, 9, or 10 mils. The curing may occur to, during, or after removing the solvent. The solvent may be reduced or completely removed, for example for evaporation, drying or by boiling it off. After removal of the solvent the composition may be characterized as “dried”.

Curing may be achieved by the conditions suitable for the curing system and cure sites used. Depending on the cure sites and curing system used curing may be achieved by heat-treating the curable fluoroelastomer composition or at room temperature, or by irradiation, for example UV-curing or actinic irradiation, for example e-beam curing. The curing is carried out at an effective temperature and effective time to create a cured fluoroelastomer. Optimum conditions can be tested by examining the fluoroelastomer for its mechanical and physical properties. Curing may be carried out under pressure or without pressure in an oven. A post curing cycle at increased temperatures and or pressure may be applied to ensure the curing process is fully completed. The curing conditions depend on the curing system used.

In some embodiments, post curing may be carried out at a temperature between 170° C. and 250° C. for a period of 0.1 to 24 hours.

In some embodiments, post curing may be carried out at lower temperatures. Post curing at lower temperatures is amenable for coating heat sensitive substrates. In some embodiments, the post curing occurs at a temperature ranging from 100, 110, 120, 130, or 140° C. up to 170° C. for a period of 5-10 minutes to 24 hours. In some embodiments, the temperature is no greater than 169, 168, 167, 166, 165, 164, 163, 162, 161, or 160° C.

The compositions may be used for impregnating substrates, printing on substrates (for example screen printing), or coating substrates, for example but not limited to spray coating, painting dip coating, roller coating, bar coating, solvent casting, paste coating. Suitable substrates may include any solid surface and may include substrate selected from glass, plastics (e.g. polycarbonate), composites, metals (stainless steel, aluminum, carbon steel), metal alloys, wood, paper among others. The coating may be coloured in case the compositions contains pigments, for example titanium dioxides or black fillers like graphite or soot, or it may be colorless in case pigments or black fillers are absent.

Bonding agents and primers may be used to pretreat the surface of the substrate before coating. For example, bonding of the coating to metal surfaces may be improved by applying a bonding agent or primer. Examples include commercial primers or bonding agents, for example those commercially available under the trade designation CHEMLOK.

Articles containing a coating from the compositions described herein include but are not limited to impregnated textiles, for example protective clothing. Textiles may include woven or non-woven fabrics. Other articles include articles exposed to corrosive environments, for example seals and components of seals and valves used in chemical processing, for example but not limited to components or linings of chemical reactors, molds, chemical processing equipment for example for etching, or valves, pumps and tubings, in particular for corrosive substances or hydrocarbon fuels or solvents; combustion engines, electrodes, fuel transportation, containers for acids and bases and transportation systems for acids and bases, electrical cells, fuel cells, electrolysis cells and articles used in or for etching.

An advantage of the coating compositions described herein is that the coating compositions can be used to prepare coatings of high or low thickness. In some embodiments, the dried and cured coating has a thickness of 0.1 microns to 1 or 2 mils. In some embodiments, the dried and cured coating thickness is at least 0.2, 0.3, 0.4, 0.5, or 0.6 microns. In some embodiments, the dried and cured coating thickness is at least 1, 2, 3, 4, 5, or 6 microns.

The dried and cured coating can exhibit good adhesion to various substrates (e.g. glass, polycarbonate,), as evidence by the coating exhibiting a 2, and preferably a 3 or 4 according to the Boiling Water Test described in the examples. In favored embodiments, the dried and cured coating is durable as evidence by the coating exhibiting a 2, and preferably a 3 or 4 according to the Abrasion Test described in the examples. In some embodiments, the coating is durable, according to the Abrasion Test after being subjected to the Boiling Water Test.

In some embodiments, the dried and cured coating compositions (disposed on a transparent substrate such as glass) has a low haze. In some embodiments, the haze is less than 10, 9, 8, 7, 6, 5, 4, 3, 2, 1 or 0.5%. In some embodiments, the haze is lower after rubbing the surface of dried and cured coating composition.

In some embodiments, the dried and cured coating has good hydrophobic and oleiphobic properties according to the Black Permanent Marker Resistance Test, i.e. the marker fluid beads and is easy to remove with a paper towel or cloth (e.g. with less than 50, 40, 30, 20, 15, 10 or 5 strokes. In some embodiments, the dried and cured coating has good hydrophobic and oleiphobic properties, as determined by Contact Angle Measurements (as determined according to the test method described in the examples).

In some embodiments, the advancing and/or receding contact angle with water can be at least 100, 105, 110, 115, 120, 125 or 130 degrees. In some embodiments, the advancing and/or receding contact angle with hexadecane can be at least 60, 65, 70, or 75 degrees. In some embodiments, the coating exhibits such contact angles, after being subjected to the Boiling Water Test or after being subject the Boiling Water Test and the Abrasion Test (as determined according to the test method described in the examples).

In some embodiments, the dried and cured coating exhibits good corrision resistance (i.e. not corroded) according to the Acid/Base Corrision Test described in the examples.

As used herein the term “partially fluorinated alkyl” means an alkyl group of which some but not all hydrogens bonded to the carbon chain have been replaced by fluorine. For example, an F₂HC—, or an FH₂C— group is a partially fluorinated methyl group. Alkyl groups where the remaining hydrogen atoms have been partially or completely replaced by other atoms, for example other halogen atoms like chlorine, iodine and/or bromine are also encompassed by the term “partially fluorinated alkyl” as long as at least one hydrogen has been replaced by a fluorine. For example, residues of the formula F₂CC— or FHCC-are also partially fluorinated alkyl residues.

A “partially fluorinated ether” is an ether containing at least one partially fluorinated group, or an ether that contains one or more perfluorinated groups and at least one non-fluorinated or at least one partially fluorinated group. For example, F₂HCO—CH₃, F₃C—O—CH₃, F₂HC—O—CFH₂, and F₂HC—O—CF₃ are examples of partially fluorinated ethers. Ethers groups where the remaining hydrogen atoms have been partially or completely replaced by other atoms, for example other halogen atoms like chlorine, iodine and/or bromine are also encompassed by the term “partially fluorinated alkyl” as long as at least one hydrogen has been replaced by a fluorine. For example, ethers of the formula F₂ClC—O—CF₃ or FHCC—O—CF₃ are also partially fluorinated ethers.

The term “perfluorinated alkyl” or “perfluoro alkyl” is used herein to describe an alkyl group where all hydrogen atoms bonded to the alkyl chain have been replaced by fluorine atoms. For example, F₃C— represents a perfluoromethyl group.

A “perfluorinated ether” is an ether of which all hydrogen atoms have been replaced by fluorine atoms. An example of s perfluorinated ether is F₃C—O—CF₃.

The following examples are provided to further illustrate the present disclosure without any intention to limit the disclosure to the specific examples and embodiments provided.

TABLE 1
Materials

| Abbreviation | Name | Source |
|---|---|---|
| PFE-1 | 30 wt. % solids aqueous perfluoroelastomer latex - 43.8 wt. % PMVE, | |
| | 52.6 wt. % TFE, and nitrile cure site monomer, as can prepared according | |
| | to WO2015/088784 or WO2015/134435 | |
| PFE-2 | 30 wt. % solids aqueous perfluoroelastomer latex - 50.4 wt. % PMVE, | |
| | 49.6 wt. % TFE, and 0.4 wt. % iodine, as can prepared according to | |
| | WO2015/088784 or WO2015/134435 | |
| Novec 7500 | Fluorinated ether solvent | 3M Company, St. Paul, MN |
| (HFE-7500) | | |
| Novec 7300 | Fluorinated ether solvent | 3M Company, St. Paul, MN |
| (HFE-7300) | | |
| PTFE | 20 wt. % solids aqueous PTFE homopolymer latex, Tm = 342° C., as can | |
| | be prepared according to EP1155055 | |
| THV-1 | 30 wt. % solids aqueous polymer latex - 76 wt. % TFE, 11 wt. % HFP, 13 | |
| | wt. % VDF, Tm = 236° C., as can be prepared according to EP1155055 | |
| THV-2 | 30 wt. % solids aqueous polymer latex - 59 wt. % TFE, 19 wt. % HFP, 22 | |
| | wt. % VDF, Tm = 165° C., as can be prepared according to EP1155055 | |
| THV340 | 3M ™, Dyneon ™ Fluoroplastic | 3M Dyneon, St. Paul, MN |
| | Dispersion THV 340Z, Tm = 140° C. | |
| | 50 wt. % solids diluted to 30 wt. % solids | |
| PFE 131TZ | 3M ™, Dyneon ™ Fluoroelastomers PFE | 3M Company, St. Paul, MN |
| | 131TZ | |
| PFA | 30 wt. % solids aqueous latex - 96 wt. % | |
| | TFE, 4 wt. % PPVE, Tm is 308° C. | |
| APMS | (3-Aminopropyl)trimethoxy silane | Sigma-Aldrich |
| BTMPA | Bis(3-trimethoxysilylpropyl)amine | Gelest Corporation, |
| | | Morrisville, PA |
| 3M ™ | N-(1,3-dimethylbutylidene)-3- | 3M, St. Paul, MN |
| Dynamer ™ Rubber | (triethoxysilyl)-1-propaneamine | |
| Curative RC5125” | | |
| Alkoxysilyl aziridine | 2-(2-methylzairidinyl) | Prepared as described in |
| (SA) | ethylcarboxylpropyltriethoxysilane | WO2015/066868 |
| DMAPS | N-dimethylaminopropyl silane | Gelest |
| TEOS | Tetraethoxysilane | Sigma-Aldrich, St. Louis, |
| | | MO |
| Soda-lime float glass | Cleaned with Alconox detergent (North | Cardinal Glass Industries |
| substrate | White Plains, NY, available through | (Eden Prairie, Minnesota |
| | Sigma-Aldrich,) water washed and IPA | USA). |
| | rinsed before use. | |
| Stainless Steel | 1 × 3 × 0.1″ or 3 × 6 × 0.1″ Cleaned by | Supplier LOFTech, St. Paul, |
| Substrate | abrading with 3M Company grade 320 | MN |
| | sandpaper and subsequently rinsed with | |
| | water and isopropyl alcohol (IPA). | |
| Polycarbonate | 4 mil thick | GE Advanced Materials |
| Substrate | | Speciality film and sheet, |
| | | Pittsfield, Mass. |

Preparation of Amorphous Perfluoroelastomer Coating Solution with Dispersed Crystalline Fluoropolymer Particles:

Perfluoroelastomer latexes PFE-1 or PFE-2 were mixed with crystalline fluoropolymer latexes PFA, PTFE, or with THV respectively at the weight ratios described in the Tables. The solutions were vortex mixing for 1-2 minutes. Subsequently, the well-mixed solutions were froze at −20° C. temperature for 4 hours, and then taken out and thawed in warm water. After thawing, the precipitates were filtered and washed with deionized (DI) water. The obtained solids were dried in an oven at 100° C. for 1-2 hours. The dried coagulated solids were mixed with the indicated fluorinated solvent (separately preparing compositions having the indicated wt. % solids of fluoropolymer (1, 2.5, 5, or 10 wt. %). Each composition was placed in a shaker for 3-4 hours obtaining a stable and well-dispersed homogeneous composition.

TABLE 1
Coating Compositions Comprising Crystalline Fluoropolymers (PFA, THV, or PTFE)
Dispersed in Amorphous Fluoropolymer (PFE-1) Fluorinated Solvent Solution

| | 10 Wt. % Solids of Specified | | |
|---|---|---|---|
| | Fluoropolymer(s) at Specified | | |
| | Weight Ratio | Fluorinated Solvent | |
| | Control PFE-1 (no crystalline | HFE-7500 | HFE-7300 |
| | fluoropolymer) | soluble | soluble |
| Ex. 1-1 | PFE-1/PFA 9:1 | stable | stable |
| Ex. 1-2 | PFE-1/PFA 8:2 | stable | stable |
| Ex. 1-3 | PFE-1/PFA 7:3 | stable | stable |
| Ex. 1-4 | PFE-1/THV-2 9:1 | stable | stable |
| Ex. 1-5 | PFE-1/THV-2 8:2 | stable | stable |
| Ex. 1-6 | PFE-1/THV-2 7:3 | stable (minor residual | stable |
| | | solid) | |
| Ex. 1-7 | PFE-1/THV-1 9:1 | stable | stable |
| Ex. 1-8 | PFE-1/THV-1 8:2 | stable | stable |
| Ex. 1-9 | PFE-1/THV-1 7:3 | stable (minor residual | stable |
| | | solid) | |
| Ex. 1-10 | PFE-1/THV340 9:1 | stable | stable |
| Ex. 1-11 | PFE-1/THV340 8:2 | stable | stable |
| Ex. 1-12 | PFE-1/PTFE 8:2 | stable | stable |
| Ex. 1-13 | PFE-1/PTFE 7:3 | stable | stable |

TABLE 2
Coating Compositions Comprising Crystalline Fluoropolymers (PFA, THV, or PTFE)
Dispersed in Amorphous Fluoropolymer (PFE-) Fluorinated Solvent Solution

| | 10 Wt. % Solids of Specified | | | |
|---|---|---|---|---|
| | Fluoropolymer(s) at Specified | Fluorinated Solvent | | |
| | Weight Ratio | HFE-7500 | HFE-7300 | PF-5060 |
| Ex. 2-1 | PFE-2 | soluble | soluble | soluble |
| Ex. 2-2 | PFE-2/PFA 9:1 | stable | stable | stable |
| Ex. 2-3 | PFE-2/PFA 8:2 | stable | stable | stable |
| Ex. 2-4 | PFE-2/PFA 7:3 | stable | stable | stable |
| Ex. 2-5 | PFE-2/THV-2 9:1 | stable | stable | stable |
| Ex. 2-6 | PFE-2/THV-2 8:2 | stable | stable | stable |
| Ex. 2-7 | PFE-2/THV-2 7:3 | stable (minor | stable | stable |
| | | residual solid) | | |
| Ex. 2-8 | PFE-2/THV-1 9:1 | stable | stable | stable |
| Ex. 2-9 | PFE-2/THV-1 8:2 | stable | stable | stable |
| Ex. 2-10 | PFE-2/THV-1 7:3 | stable (minor | stable | stable |
| | | residual solid) | | |
| Ex. 2-11 | PFE-2/THV340 9:1 | stable | stable | stable |
| Ex. 2-12 | PFE-2/THV340 8:2 | stable | stable | stable |
| Ex. 2-13 | PFE-2/PTFE 8:2 | stable | stable | stable |
| Ex. 2-14 | PFE-2/PTFE 7:3 | stable | stable | stable |
| Ex. 2-15 | PFE-1/PFE-2/PTFE | stable | stable | NT |
| | 4:4:2 | | | |
| Ex. 2-16 | PFE-1/PFE-2/PTFE | stable | stable | NT |
| | 3.5:3.5:3.0 | | | |

### Crosslinking Test:

10 wt. % fluoropolymer coating compositions were prepared as described above utilizing HFE7500. The solutions were separately coated on aluminum coupons. The samples were quickly air-dried and subsequently cured at 150° C., 200° C. and 300° C. for 5-10 minutes separately. The resulting cured coating films were peeled off and placed in HFE-7500 separately. The solutions were stirred overnight to determine if films were soluble or not soluble in the HFE-7500 solvent. Films that were not soluble in the solvent were considered crosslinked.

TABLE 3
Crosslinking Effect of Dispersed Crystalline Fluoropolymer Particles

| | 10 Wt. % Solids of | | | |
|---|---|---|---|---|
| | Specified | | | |
| | Fluoropolymer(s) at | | | |
| | Specified Weight Ratio | 150° C. 10 min | 200° C. 10 min | 300° C. 10 min |
| Ex. 3-1 | PFE-1 | Soluble in HFE-7500 | Soluble in HFE-7500 | Soluble in HFE-7500 |
| Ex. 3-2 | PFE-2 | Soluble in HFE-7500 | Soluble in HFE-7500 | Soluble in HFE-7500 |
| Ex. 3-3 | PFE-1/PFA | Soluble* | Not soluble | Not soluble |
| | 7:3 | in HFE-7500 | in HFE-7500 | in HFE-7500 |
| Ex. 3-4 | PFE-2/PFA | Soluble* | Not soluble | Not soluble |
| | 7:3 | in HFE-7500 | in HFE-7500 | in HFE-7500 |
| Ex. 3-5 | PFE-1/THV-1 | Soluble* | Not soluble | Not soluble |
| | 8:2 | in HFE-7500 | in HFE-7500 | in HFE-7500 |

*Minor solid residue

### Coating Solution Applied to Glass Substrate:

Solutions of amorphous perfluoroelastomers with dispersed crystalline fluoropolymer particles were prepared as described above. Amine and organosilane compounds were added at the wt. % solids indicated in the Tables. The coating solutions were vortex mixed for 1-2 min at 2500 RPM or shaken, until the coating was homogeneous.

The coating solutions were applied with a No. 12 Meyer rod to the glass substrate (described in Table 1). Unless specified otherwise, the coatings were dried and cured for 10 minutes at the temperature specified in the Tables. The 1 wt. % solutions provided a dried and cured coating thickness of 0.2 to 0.6 microns. The 2.5 wt. % solutions provided a dried and cured coating thickness of 0.5 to 1.5 microns. The 5 wt. % solutions provided a dried and cured coating thickness of 1-3 microns. The 10 wt. % solutions provided a dried and cured coating thickness of 2-6 microns. The coated substrate was evaluated with the following tests.

### Bonding Evaluation:

The bonding of the dried and cured coating to the substrate was evaluated according to the following criteria.

0—Coating boiled off

1—Coating peels off easily

2—Coating peels off with moderate force

3—Coating peels off with greater force

4—Coating breaks upon peeling

### Boiling Water Test:

The coated glass substrate having the dried and cured coating was submerged in a beaker of boiling water for 2 hours. After boiling, the bonding was evaluated as described above.

### Abrasion Testing:

A TABER 5900 liner abrader (obtained from Taber Industries of North Tonawanda, NY) fitted with a 2.5 cm button covered with a KIMBERLY-CLARK L-30 WYPALL towel (obtained from Kimberly Clark of Roswell, GA) and a 5.1 cm×5.1 cm crock cloth (obtained from Taber Industries, North Tonawanda, NY). The samples were abraded for 200 to 500 cycles at a rate of 20 cycles/minute (1 cycle consisted of a forward wipe followed by a backward wipe) with a load of 1000 grams following ASTM D0460 and a stroke length of 5.1 cm.

Abrasion Testing was conducted on coated substrates before and after the coated substrate was subjected to the Boiling Water Test. After Abrasion Testing the coated sample was evaluated according to the following criteria:

0—Coating is completely abraded off

1—Coating is partially abraded off

2—Coating is slightly abraded off, visible abrasion mark on coating

3—Coating is not abraded off, visible abrasion mark on coating

4—Coating is not abraded off, very faint abrasion mark on coating

### Black Permanent Marker Resistance Test:

A 3-5 mm wide straight line was drawn on the dried and cured coating of the coated substrate using a black Sharper™ permanent marker with the help of a ruler at a speed of roughly 6 inches per second (0.15 m/s). The mark left on the coating surface was a solid line. If this line could not be removed by rubbing with a paper towel or a cloth with less than 30 strokes, the surface was not considered to be an oleophobic surface. If this line could be removed by rubbing with a paper towel or a cloth with less than 30 strokes the coating surface was considered to have “Good” hydrophobic and oleophobic and the number of strokes was typically recorded.

### Contact Angle Measurement:

Contact angle measurements were made on the dried and cured coating of the coated glass substrate before and after subjecting the sample to Abrasion Testing. The Abrasion Testing was conducted on samples before and after being subjected to the Boiling Water Test. The resulting coatings were rinsed for 1 minute by hand agitation in isopropanol alcohol before being subjected to measurement of water and hexadecane contact angles. Measurements were made using as-received reagent-grade hexadecane (Sigma-Aldrich) and deionized water filtered through a filtration system obtained from Millipore Corporation (Billerica, Mass.), on a video contact angle analyzer available as product number VCA-2500XE from AST Products (Billerica, Mass.). Reported values were the averages of measurements on at least three drops measured on the right and the left sides of the drops, and are shown in the Tables. Drop volumes were 5 microliters for static measurements and 1-3 microliters for advancing and receding contact angles. For hexadecane, only advancing and receding contact angles are reported because the static and advancing values were found to be nearly equal.

Haze was measured using a HAZE-GARD PLUS instrument.

TABLE 4
Test Results of Coatings Applied to Polycarbonate Substrate Cured at 120° C. for 10 minutes

| | | | | Abrasion Test (1000 cycle) | | | Abrasion Test (1000 cycle) | | |
|---|---|---|---|---|---|---|---|---|---|
| | 2.5 Wt. % Solids of | Initial properties | | Before in boiling water | | | After in boiling water | | |
| | Specified | | Marker | | | Marker | | | Marker |
| | Fluoropolymer(s) at | | Removal | | Abrasion | Removal | | Abrasion | Removal |
| | Specified Weight Ratio | Haze | Strokes | Haze | Rating | strokes | Haze | Rating | strokes |
| Ex. | Control PFE-1 | 0.2 | 3 | 3.52 | 3 | No | 2.11 | 3 | No |
| 4-1 | 3% BTMPA, 1.5% | | | | | | | | |
| | TEOS | | | | | | | | |
| Ex. | PFE-1/PFA = 90/10, | 1.69 | 3 | 2.99 | 3 | 20 | 2.84 | 3 | No |
| 4-2 | 3% BTMPA, 1.5% | | | | | | | | |
| | TEOS | | | | | | | | |
| Ex. | PFE-1/PFA = 80/20, | 4.61 | 3 | 4.92 | 4 | 8 | 4.16 | 4 | 8 |
| 4-3 | 3% BTMPA, 1.5% | | | | | | | | |
| | TEOS | | | | | | | | |
| Ex. | PFE-1/PFA = 70/30, | 5.21 | 2 | 2.57 | 4 | 5 | 2.29 | 4 | 4 |
| 4-4 | 3% BTMPA 1.5% | | | | | | | | |
| | TEOS | | | | | | | | |

TABLE 5
Test Results of 5 Wt. % Coatings Applied to Polycarbonate Substrate Cured at 120° C. for 10 minutes

| | | | | Abrasion Test (1000 cycle) | | | Abrasion Test (1000 cycle) | | |
|---|---|---|---|---|---|---|---|---|---|
| | 5 Wt. % Solids of | Initial properties | | Before in boiling water | | | After in boiling water | | |
| | Specified | | Marker | | | Marker | | | Marker |
| | Fluoropolymer(s) at | | Removal | | Abrasion | Removal | | Abrasion | Removal |
| | Specified Weight Ratio | Haze | Strokes | Haze | Rating | Strokes | Haze | Rating | strokes |
| Ex. | Control PFE-1 | 0.54 | 5 | 1.42 | 3 | No | 2.08 | 3 | No |
| 5-1 | 3% BTMPA, 1.5% | | | | | | | | |
| | TEOS | | | | | | | | |
| Ex. | PFE-1/PFA = 90/10, | 3.48 | 3 | 1.80 | 3 | 20 | 2.25 | 3 | No |
| 5-2 | 3% BTMPA, 1.5% | | | | | | | | |
| | TEOS | | | | | | | | |
| Ex. | PFE-1/PFA = 80/20, | 6.23 | 3 | 4.42 | 4 | 9 | 3.17 | 4 | 8 |
| 5-3 | 3% BTMPA, 1.5% | | | | | | | | |
| | TEOS | | | | | | | | |
| Ex. | PFE-1/PFA = 70/30, | 17.7 | 3 | 5.73 | 4 | 3 | 5.28 | 4 | 5 |
| 5-4 | 3% BTMPA 1.5% | | | | | | | | |
| | TEOS | | | | | | | | |

TABLE 6
Test Results of 2.5 Wt. % Coatings Applied to Glass and Cured at 200° C. for 10 minutes

| | | | Abrasion Test (1000 cycle) | | | Abrasion Test (1000 cycle) | | |
|---|---|---|---|---|---|---|---|---|
| 2.5 Wt. % Solids of | Initial properties | | Before in boiling water | | | After in boiling water | | |
| Specified | | Marker | | | Marker | | | Marker |
| Fluoropolymer(s) at | | Removal | | Abrasion | Removal | | Abrasion | Removal |
| Specified Weight Ratio | Haze | Strokes | Haze | Rating | strokes | Haze | Rating | Strokes |
| Ex. 6-1 - Control | 0.94 | 6 | 2.33 | 1 | No | 2.51 | 1 | No |
| PFE-1 | | | | | | | | |
| 3% BTMPA, | | | | | | | | |
| 1.5% TEOS | | | | | | | | |
| Ex. 6-2 - PFE- | 1.63 | 5 | 2.06 | 3 | 25 | 2.18 | 3 | 15 |
| 1/PFA = 90/10, | | | | | | | | |
| 3% BTMPA, | | | | | | | | |
| 1.5% TEOS | | | | | | | | |
| Ex. 6-3 - PFE- | 6.00 | 3 | 3.29 | 4 | 15 | 2.99 | 4 | 11 |
| 1/PFA = 80/20, | | | | | | | | |
| 3% BTMPA, | | | | | | | | |
| 1.5% TEOS | | | | | | | | |
| Ex. 6-4 - PFE- | 7.91 | 3 | 4.15 | 4 | 6 | 3.02 | 4 | 6 |
| 1/PFA = 70/30, | | | | | | | | |
| 3% BTMPA | | | | | | | | |
| 1.5% TEOS | | | | | | | | |

TABLE 7
Test Results of 5 Wt. % Coatings Applied to Glass and Cured at 200° C. for 10 minutes

| | | | Abrasion Test (1000 cycle) | | | Abrasion Test (1000 cycle) | | |
|---|---|---|---|---|---|---|---|---|
| 5 Wt. % Solids of | Initial properties | | Before in boiling water | | | After in boiling water | | |
| Specified | | Marker | | | Marker | | | Marker |
| Fluoropolymer(s) at | | Removal | | Abrasion | Removal | | Abrasion | Removal |
| Specified Weight Ratio | Haze | Strokes | Haze | Rating | strokes | Haze | Rating | Strokes |
| Ex. 7-1 - Control | 0.49 | 20, a | 2.63 | 1 | No | 4.60 | 1 | No |
| PFE-1 | | little left | | | | | | |
| 5 wt. %, 3% BTMPA, | | | | | | | | |
| 1.5% TEOS | | | | | | | | |
| Ex. 7-2 - PFE- | 2.19 | 15 | 2.75 | 1 | No | 3.50 | 3 | No |
| 1/PFA = 90/10, | | | | | | | | |
| 5 wt %, 3% BTMPA, | | | | | | | | |
| 1.5% TEOS | | | | | | | | |
| Ex. 7-3 - PFE- | 2.86 | 8 | 2.86 | 4 | 10 | 1.73 | 4 | 8 |
| 1/PFA = 80/20, | | | | | | | | |
| 5 wt. %, 3% BTMPA, | | | | | | | | |
| 1.5% TEOS | | | | | | | | |
| Ex. 7-4 - PFE- | 4.09 | 4 | 3.17 | 4 | 6 | 3.01 | 4 | 5 |
| 1/PFA = 70/30, | | | | | | | | |
| 5 wt. %, 3% BTMPA | | | | | | | | |
| 1.5% TEOS | | | | | | | | |

TABLE 8
Contact angles of the Fluoropolymer Coatings
on Glass Cured at 200° C. for 10 minutes

| 1 Wt. % Solids of | | | | | | | | |
|---|---|---|---|---|---|---|---|---|
| Specified | Initial properties | | | | After in boiling water | | | |
| Fluoropolymer(s) at | H2O | | Hexadecane | | H2O | | Hexadecane | |
| Specified Weight Ratio | Adv. | Rec. | Adv. | Rec. | Adv. | Rec. | Adv. | Rec. |
| Ex. 8-1 - Control PFE-1 | 127.8 | 90.6 | 72.6 | 53.8 | 15.9 | 8.3 | 11.0 | 6.9 |
| Ex. 8-2 - PFE-1, 3% | 120.0 | 93.5 | 70.8 | 57.6 | 122.4 | 78.0 | 70.9 | 50.6 |
| BTMPA, 1.5% TEOS | | | | | | | | |
| Ex. 8-3 - PFE-1/PFA | 125.6 | 87.2 | 69.5 | 54.4 | 125.8 | 62.3 | 71.5 | 45.7 |
| 9/1, 3% BTMPA, 1.5% | | | | | | | | |
| TEOS | | | | | | | | |
| Ex. 8-4 - PFE-1/PFA | 127.5 | 95.5 | 69.8 | 49.2 | 123.9 | 70.9 | 73.6 | 43.1 |
| 8/2, 3% BTMPA, 1.5% | | | | | | | | |
| TEOS | | | | | | | | |
| Ex. 8-5 - PFE-1/PFA | 130.5 | 82.9 | 71.0 | 46.1 | 125.8 | 68.4 | 70.6 | 37.9 |
| 7/3, 3% BTMPA, 1.5% | | | | | | | | |
| TEOS | | | | | | | | |

TABLE 9
Contact angles of the Fluoropolymer Coatings
on Glass Cured at 200° C. for 10 minutes

| 2.5 Wt. % Solids of | | | | | | | | |
|---|---|---|---|---|---|---|---|---|
| Specified | Initial Properties | | | | After in boiling water | | | |
| Fluoropolymer(s) at | H2O | | Hexadecane | | H2O | | Hexadecane | |
| Specified Weight Ratio | Adv. | Rec. | Adv. | Rec. | Adv. | Rec. | Adv. | Rec. |
| Ex. 9-1 - Control PFE-1 | 133.4 | 95.8 | 79.3 | 59.1 | 14.8 | 4.7 | 12.3 | 5.6 |
| Ex. 9-2 - PFE-1, 3% | 123.0 | 92.7 | 72.3 | 53.2 | 117.4 | 59.4 | 71.4 | 50.0 |
| BTMPA, 1.5% TEOS | | | | | | | | |
| Ex. 9-3 - PFE-1/PFA | 123.5 | 93.3 | 71.1 | 53.8 | 125.1 | 64.8 | 73.1 | 46.5 |
| 9/1, 3% BTMPA, 1.5% | | | | | | | | |
| TEOS | | | | | | | | |
| Ex. 9-4 - PFE-1/PFA | 120.0 | 87.0 | 71.4 | 52.5 | 125.8 | 66.2 | 74.2 | 47.1 |
| 8/2, 3% BTMPA, 1.5% | | | | | | | | |
| TEOS | | | | | | | | |
| Ex. 9-5 - PFE-1/PFA | 130.5 | 82.9 | 71.5 | 51.9 | 122.7 | 63.4 | 72.9 | 44.4 |
| 7/3, 3% BTMPA, 1.5% | | | | | | | | |
| TEOS | | | | | | | | |

TABLE 10
Contact angles of the Fluoropolymer Coatings
on Glass Cured at 200° C. for 10 minutes

| 1 Wt. % Solids of | After Abrasion Test | | | | After boiling water & Abrasion Test | | | |
|---|---|---|---|---|---|---|---|---|
| Specified | (1000 cycles) | | | | (1000 cycles) | | | |
| Fluoropolymer(s) at | H2O | | Hexadecane | | H2O | | Hexadecane | |
| Specified Weight Ratio | Adv. | Rec. | Adv. | Rec. | Adv. | Rec. | Adv. | Rec. |
| Ex. 10-1 - Control PFE- | 118.9 | 64.4 | 68.6 | 53.4 | 118.6 | 56.4 | 65.8 | 46.1 |
| 1 3% BTMPA, 1.5% | | | | | | | | |
| TEOS | | | | | | | | |
| Ex. 10-2 - PFE-1/PFA | 117.5 | 70.1 | 64.2 | 49.1 | 120.0 | 70.6 | 67.8 | 49.1 |
| 9/1, 3% BTMPA, 1.5% | | | | | | | | |
| TEOS | | | | | | | | |
| Ex. 10-3 - PFE-1/PFA | 120.4 | 74.1 | 64.3 | 48.4 | 112.9 | 73.3 | 66.2 | 49.9 |
| 8/2, 3% BTMPA, 1.5% | | | | | | | | |
| TEOS | | | | | | | | |
| Ex. 10-4 - PFE-1/PFA | 118.7 | 80.8 | 61.0 | 53.0 | 96.9 | 42.5 | 61.5 | 49.5 |
| 7/3, 3% BTMPA, 1.5% | | | | | | | | |
| TEOS | | | | | | | | |

TABLE 11
Contact Angles of the Fluoropolymer Coatings on Glass Cured at 200° C. for 10 minutes

| 2.5 Wt. % Solids of | After Abrasion Test | | | | After boiling water & Abrasion Test | | | |
|---|---|---|---|---|---|---|---|---|
| Specified | (1000 cycles) | | | | (1000 cycles) | | | |
| Fluoropolymer(s) at | H2O | | Hexadecane | | H2O | | Hexadecane | |
| Specified Weight Ratio | Adv. | Rec. | Adv. | Rec. | Adv. | Rec. | Adv. | Rec. |
| Ex. 11-1 - Control PFE- | 98.9 | 45.5 | 68.5 | 49.4 | 118.7 | 68.8 | 69.7 | 50.6 |
| 13% BTMPA, 1.5% TEOS | | | | | | | | |
| Ex. 11-2-PFE-1/PFA | 117.5 | 70.1 | 68.4 | 51.0 | 123.9 | 73.9 | 69.9 | 47.9 |
| 9/1, 3% BTMPA, 1.5% | | | | | | | | |
| TEOS | | | | | | | | |
| Ex. 11-3 - PFE-1/PFA | 101.2 | 64.6 | 68.7 | 49.1 | 121.3 | 61.0 | 69.9 | 45.8 |
| 8/2, 3% BTMPA, 1.5% | | | | | | | | |
| TEOS | | | | | | | | |
| Ex. 11-4-PFE-1/PFA | 91.0 | 60.6 | 68.1 | 49.5 | 118.2 | 73.5 | 65.4 | 50.8 |
| 7/3 2.5%, 3% BTMPA, | | | | | | | | |
| 1.5% TEOS | | | | | | | | |

TABLE 12
Contact Angles of the Fluoropolymer Coatings on Glass Cured at 200° C. for 10 minutes

| | After Abrasion Test | | | | After boiling water & Abrasion Test | | | | |
|---|---|---|---|---|---|---|---|---|---|
| Fluoropolymer | (1000 cycles) | | | | (1000 cycles) | | | | Marker |
| coating composition | H2O | | Hexadecane | | H2O | | Hexadecane | | Removal |
| (1 wt.%) | Adv. | Rec. | Adv. | Rec. | Adv. | Rec. | Adv. | Rec. | strokes |
| Ex. 12-1 - Control | 118.6 | 56.4 | 65.8 | 46.1 | 93.2 | 50.3 | 24.7 | 8.4 | 1 |
| PFE-1, 3% BTMPA, | | | | | | | | | |
| 1.5% TEOS | | | | | | | | | |
| Ex. 12-2 - PFE- | 120.0 | 70.6 | 67.8 | 49.1 | 115.4 | 69.1 | 67.0 | 44.5 | 12 |
| 1/PFA 9/1, 3% | | | | | | | | | |
| BTMPA, 1.5% | | | | | | | | | |
| TEOS | | | | | | | | | |

TABLE 13
Contact Angles of the Fluoropolymer Coatings
on Glass (cured at 200° C. for 5-10 minutes)

| | After boiling water immersion & | | | | Marker test | |
|---|---|---|---|---|---|---|
| Fluoropolymer coating | 1000 cycles of abrasion | | | | (first 10 times | Marker |
| composition | H2O | | Hexadecane | | were done at | Removal |
| (2.5 wt. %) | Adv. | Rec. | Adv. | Rec. | 5 min. interval) | strokes |
| Ex. 13-1 - | 118.7 | 68.8 | 69.7 | 50.6 | >10 | No |
| ControlPFE-1 3% | | | | | | |
| BTMPA, 1.5% TEOS | | | | | | |
| Ex. 13-2 - PFE-1/PFA | 123.9 | 73.9 | 69.9 | 47.9 | >10 | Yes |
| 9/1, 3% BTMPA, | | | | | | |
| 1.5% TEOS | | | | | | |
| Ex. 13-3 - PFE-1/PFA | 121.3 | 61.0 | 69.9 | 45.8 | >10 | Yes |
| 8/2, 3% BTMPA, | | | | | | |
| 1.5% TEOS | | | | | | |
| Ex. 13-4 - PFE-1/PFA | 118.2 | 73.5 | 65.4 | 50.8 | >10 | Yes |
| 7/3, 3% BTMPA, | | | | | | |
| 1.5% TEOS | | | | | | |

TABLE 14
Contact Angles of the Fluoropolymer Coatings
on Glass (cured at 200° C. for 5-10 minutes)

| Fluoropolymer coating | Initial properties | | | | After Abrasion Test (1000 cycles) | | | |
|---|---|---|---|---|---|---|---|---|
| composition | H2O | | Hexadecane | | H2O | | Hexadecane | |
| (2.5 wt. %) | Adv. | Rec. | Adv. | Rec. | Adv. | Rec. | Adv. | Rec. |
| Ex. 14-1 - Control PFE- | 114.5 | 86.3 | 61.2 | 36.7 | 119.8 | 77.2 | 63.3 | 40.4 |
| 1 3% BTMPA, 1.5% | | | | | | | | |
| TEOS | | | | | | | | |
| Ex. 14-2 - PFE-1/PFA | 124.5 | 87.5 | 72.2 | 49.3 | 103.8 | 87.7 | 64.8 | 49.8 |
| 8/2, 3% BTMPA, 1.5% | | | | | | | | |
| TEOS | | | | | | | | |
| Ex. 14-3 - PFE-1/PFA | 121.8 | 87.6 | 69.7 | 48.4 | 104.0 | 87.2 | 64.5 | 48.6 |
| 7/3, 3% BTMPA, 1.5% | | | | | | | | |
| TEOS | | | | | | | | |

TABLE 15
Contact Angles of the Fluoropolymer Coatings
on Glass (cured at 200° C. for 5-10 minutes)

| Fluoropolymer coating | Initial properties | | | | After 1000 abrasion cycles | | | |
|---|---|---|---|---|---|---|---|---|
| composition | H2O | | Hexadecane | | H2O | | Hexadecane | |
| (5 wt. %) | Adv. | Rec. | Adv. | Rec. | Adv. | Rec. | Adv. | Rec. |
| Ex. 15-1 - PFE-1/PFA | 124.4 | 87.4 | 69.9 | 49.2 | 105.9 | 86.6 | 70.4 | 50.4 |
| 9/1, 3% BTMPA, 1.5% | | | | | | | | |
| TEOS | | | | | | | | |
| Ex. 15-2 - PFE-1/PFA | 123.5 | 85.2 | 68.0 | 41.9 | 100.0 | 84.4 | 64.8 | 47.8 |
| 8/2, 3% BTMPA, 1.5% | | | | | | | | |
| TEOS | | | | | | | | |
| Ex. 15-3 - PFE-1/PFA | 126.1 | 86.8 | 70.3 | 41.0 | 106.5 | 87.3 | 62.4 | 49.5 |
| 7/3, 3% BTMPA, 1.5% | | | | | | | | |
| TEOS | | | | | | | | |

5 wt. % PFE-THV dispersion solutions in HFE-7500 described in the Table were mixed with APS in methanol (50 wt. %) and TEOS in methanol (50 wt. %) to obtain the stable solutions containing 3 wt. % APS and 1.5 wt. % TEOS based on the solid of PFE-THV coagulated materials.

### Table 16

Stainless steel coupons cleaned and polished with 3M 320 sand paper and further cleaned with IPA. The solutions were coated by drop casting, dried at 100° C. for 10 minutes. The thickness after drying was 1-2 mils. On the top of the PFE-THV coatings was coated PFE 131TZ (l0 wt. % in HFE-7500 containing 3 wt. % of BTMPA and 1.5 wt. % of TEOS based on the solid of PFE-1TZ). The coated samples were cured at 140° C. for 10 minutes. The PFE 131TZ solution was used to create a thick layer coating (coating thickness=2 mils) on thin PFE coating (control) or on the PFE-THV coatings.

TABLE 16
PFE 40 coating adhesion to stainless steel improved by THV fluoroplastic nanoparticles

| | | | After boiling water | | |
|---|---|---|---|---|---|
| | Initial properties | | Adhesion of | | |
| Fluoropolymer coating composition | Adhesion of | | Coating to | | Cross- |
| (5wt. %) | Coating to SS | PFE-1TZ | SS | PFE-1TZ | linked |
| Ex. 16-1 - Control PFE-2 | 2 | 1 | 1 | 1 | N |
| Ex. 16-2- PFE-2/THV 500 = 80/20 + | 3 | 3 | 3 | 3 | Y |
| 3% APS + 1.5% TEOS | | | | | |
| Ex. 16-3 - PFE-2/THV 500 = 70/30 + | 5 | 5 | 4 | 4 | Y |
| 3% APS + 1.5% TEOS | | | | | |
| Ex. 16-4- PFE-2/THV 800 = 70/30 + | 5 | 5 | 4.5 | 4.5 | Y |
| 3% APS + 1.5% TEOS | | | | | |
| Ex.16-5 - PFE-1/THV 800 = 80/20 + | 5 | 5 | 4.5 | 4.5 | Y |
| 3% APS + 1.5% TEOS | | | | | |
| (solution has a limited shelf life) | | | | | |

Coating the Perfluoroelastomer Coating Solution onto a Substrate:

The coating solutions described in the following Tables were coated onto the aluminum substrate (described in Table) by drop casting. The resulting coating coatings were allowed to air dry and were subsequently placed into an oven at 200° C. for 10 minutes. The thickness of the dried and cured coating was 1-2 mils.

The coated substrates were evaluated with the following Acid/Base Corrosion Tests.

### Acid/Base Corrosion Tests:

Concentrated NaOH (33 wt. %) and dilute HNO₃ (7 wt. %) were prepared. Coated substrates were then separately placed in the NaOH and HNO₃ solutions for 24 hours. The tested samples were taken out and rinsed with water to observe if the aluminum was corroded.

TABLE 17
Aluminum Corrosion Resistance Test Against Conc. Aqueous NaOH

| | | Aqueous NaOH |
|---|---|---|
| | Coating composition: 10 wt. % PFE-1/PFA in HFE-7500 | (33 wt. %) |
| Ex. 17-1 | PFE-1/PFA 90:10, 3% BTMPA, 1.5% TEOS | Not corroded |
| Ex. 17-2 | PFE-1/PFA 80:20, 3% BTMPA, 1.5% TEOS | Not corroded |
| Ex. 17-3 | PFE-1/PFA 70:30, 3% BTMPA, 1.5% TEOS | Not corroded |

TABLE 18
Aluminum Corrosion Resistance Test Against Aqueous HNO3

| | Coating composition: 10 wt. % PFE-1/PFA in HFE-7500 | Aqueous HNO3 (7wt. %) |
|---|---|---|
| Ex. 18-1 | PFE-1/PFA 90:10, 3% BTMPA, 1.5% TEOS | Not corroded |
| Ex. 18-2 | PFE-1/PFA 80:20, 3% BTMPA, 1.5% TEOS | Not corroded |
| Ex. 18-3 | PFE-1/PFA 70:30, 3% BTMPA, 1.5% TEOS | Not corroded |

1. A method for making a fluoropolymer coating composition comprising blending a latex containing crystalline submicron fluoropolymer particles with a latex containing amorphous fluoropolymer particles, wherein the amorphous fluoropolymer particles comprises at least 90 wt-% of polymerized units derived from perfluorinated monomers selected from tetrafluoroethene (TFE) and one or more perfluorinated alkyl ethers;
coagulating and drying the blended latexes; and
dissolving the dried blend in a fluorinated solvent.

2. The method of claim 1 wherein the perfluorinated alkyl ether has the general formula
R_{f}—O—(CF₂)ₙ—CF═CF₂
wherein n is 1 or 0 and R_{f} is a perfluoroalkyl group that optionally comprises one or more contiguous oxygen atoms.

3. The method of claim 1 comprising coagulating the latexes by chilling.

4. The method of claim 1 further comprising applying a layer of the coating composition to a support and drying the applied layer.

5. The method of claim 4 further comprising rubbing the dried layer thereby forming an amorphous fluoropolymer binder layer containing crystalline submicron fluoropolymer particles.

6. The method of claim 1 wherein the fluorinated solvent has a GWP of less than 1000.

7. The method of claim 1 wherein the fluorinated solvent comprises a branched, partially fluorinated ether and wherein the partially fluorinated ether corresponds to the formula:
Rf—O—R
wherein Rf is a selected from perfluorinated and partially fluorinated alkyl or (poly)ether groups and R is selected from partially fluorinated and non-fluorinated alkyl groups.

8. The composition of claim 1 wherein the partially fluorinated ether of the solvent corresponds to the formula:
CₚF₂ₚ₊₁—O—C_{q}H_{2q+1}
wherein q is an integer from 1 to 5 and p is an integer from 5 to 11.

9. A fluoropolymer composition comprising crystalline submicron fluoropolymer particles dispersed in a solution of fluorinated solvent and amorphous fluoropolymer; wherein the amorphous fluoropolymer comprises at least 90 wt-% of polymerized units derived from perfluorinated monomers selected from tetrafluoroethene (TFE) and one or more unsaturated perfluorinated alkyl ethers.

10. The fluoropolymer composition of claim 9 wherein the unsaturated perfluorinated alkyl ether of the fluoropolymer has the general formula
R_{f}—O—(CF₂)ₙ—CF═CF₂
wherein n is 1 or 0 and R_{f} is a perfluoroalkyl or perfluoroether group.

11. The fluoropolymer composition of claim 9 wherein the crystalline submicron fluoropolymer particles are thermoplastic.

12. The fluoropolymer composition of claim 9 wherein the crystalline submicron fluoropolymer particles comprise a homopolymer of tetrafluoroethylene or a copolymer of tetrafluoroethylene, vinylidene fluoride, and hexafluoropropylene.

13. The fluoropolymer composition of claim 9 wherein the crystalline submicron fluoropolymer particles have an average particle diameter in the range of 50 to 200 nm.

14. The fluoropolymer composition of claim 9 wherein the composition comprises 5 to 60 weight percent of crystalline submicron fluoropolymer particles and 40 to 95 weight percent amorphous fluoropolymer, based on the total weight of solid components of the coating composition.

15. The fluoropolymer composition of claim 9 wherein the composition further comprises a compound comprising at least one amine group or an alkoxy silane compound that lacks one or more amine group.

16-20. (canceled)

21. The fluoropolymer composition according to claim 9 wherein the fluorinated solvent comprises a branched, partially fluorinated ether and wherein the partially fluorinated ether corresponds to the formula:
Rf—O—R
wherein Rf is a selected from perfluorinated and partially fluorinated alkyl or (poly)ether groups and R is selected from partially fluorinated and non-fluorinated alkyl groups.

22-23. (canceled)

24. A fluoropolymer composition comprising crystalline submicron fluoropolymer particles dispersed in an amorphous fluoropolymer binder layer; wherein the amorphous fluoropolymer binder layer comprises at least 90 wt-% of polymerized units derived from perfluorinated monomers selected from tetrafluoroethene (TFE) and one or more unsaturated perfluorinated alkyl ethers.

25. (canceled)

26. A substrate comprising a coated surface wherein the surface comprises the fluoropolymer composition of claim 24.

27. A substrate comprising a coated surface wherein a fluoropolymer composition of claim 24 is disposed on the substrate and a layer of amorphous fluoropolymer lacking crystalline submicron fluoropolymer particles is disposed on the fluoropolymer composition.
